(19) United States
(12) Patent Application Publication
(10) Pub. No.: US 2026/0181490 A1
(43) Pub. Date: Jun. 25, 2026

(54) MANAGING NETWORK CONNECTIVITY IN A WIRELESS COMMUNICATION SYSTEM

(71) Applicant: CANON KABUSHIKI KAISHA, Tokyo (JP)

(72) Inventors: Pascal LAGRANGE, LA CHAPELLE DES FOUGERETZ (FR); Pierre VISA, RENNES (FR)

(21) Appl. No.: 19/125,035

(22) PCT Filed: Oct. 30, 2023
(86) PCT No.: PCT/EP2023/080280

§ 371 Date: Apr. 28, 2025

(30) Foreign Application Priority Data
Nov. 3, 2022 (GB) 2216352.1
May 11, 2023 (GB) 2307020.4
Jul. 11, 2023 (GB) 2310627.1

(51) Int. Cl. H04W 36/00

(52) U.S. Cl. CPC H04W 36/0058

(57) ABSTRACT

A method of determining, in a wireless network comprising a user equipment, UE, connected to a donor Integrated Access and Backhaul, IAB, node via a mobile Integrated Access and Backhaul, mIAB, node, an on-board status of the UE, the method comprising: monitoring whether an on-board triggering condition is satisfied; and determining that the UE has an on-board status when the on-board triggering condition is satisfied.

### FIELD OF THE INVENTION

The present invention generally relates to managing network connectivity in a wireless communication system. Particularly, the present invention relates to managing network connectivity in a wireless communication system including at least one mobile Integrated Access and Backhaul, IAB, node.

### BACKGROUND

Wireless communication systems are largely deployed to address a wide range of applications, from mobile broadband, massive machine type communications to Ultra Reliable Low Latency Communications (URLLC). Such systems allow a plurality of user equipment (UE) or mobile terminals to share the wireless medium to exchange several types of data content (e.g., video, voice, messaging . . . ) over a radio access network (RAN) through one or more base stations. The base stations are conventionally wired-connected (e.g. through fiber) to a core network, forming an intermediate network, named backhaul (BH).

Examples of such wireless multiple-access communication systems include systems based on 3rd generation partnership project (3GPP-RTM) standards, such as fourth-generation (4G) Long Term Evolution (LTE) or recent fifth-generation (5G) New Radio (NR) systems, or systems-based IEEE 802.11 standards, such as WiFi.

The demand for network densification increases due to the rising number of users and higher throughput requirement.

Facing the issues of high deployment costs and time of the wired backhaul networks with network densification, 3GPP has proposed, in recent release 16 for 5G NR, a wireless backhaul, also known as Integrated Access and Backhaul, IAB, where part of the wireless (i.e. radio) spectrum is used for the backhaul connection of base stations instead of fiber. The wireless backhaul communications (between base stations) may use the same radio resources as access communications (between a base station and UEs).

IAB turns out to be a competitive alternative to the fiber-based backhauling in dense areas or areas difficult to cover, as it allows scalable and rapid installations without the burden of cabling the base stations.

IAB is most likely to operate in the millimeter wave (mmWave) band to achieve the required Gbps (gigabits per second) data rate.

Urban environments are usually characterised by a high density of users along with the presence of a significant number of vehicles (e.g. public/private passengers transportation, goods delivery, food trucks . . . ). The speed of some of the vehicles may be pretty low or at least similar to pedestrian speed and some of these vehicles may even be temporarily stationary. Some of these vehicles (e.g. buses, trains or trams), may have predictable routes and/or limited mobility areas (e.g. some vehicles, such as food trucks or promotional vehicles, may be located outside stadiums or show venues) while others may have predictable stationary locations (e.g. taxis).

3GPP is considering that such vehicles could offer an opportunity to increase network coverage and connectivity to the UEs inside the vehicles, or even to UEs in proximity to the vehicles, by installing on these vehicles on-board base stations (or base station elements) that would act as relays. These relays would rely on 5G wireless backhaul (typically IAB, or Integrated Access & Backhaul) for connecting to a fixed donor device. Thus, based upon the fixed IAB foundations set out in Releases 16 and 17, 3GPP is now considering Mobile IAB systems and architecture, as a part of the Release 18 framework, in order to address scenarios focusing on mobile IAB-nodes mounted on vehicles (for example, a bus, a train, a taxi). In such scenarios, mobile IAB-nodes can also be referred to as Vehicle Mounted Relays (VMR), providing 5G coverage/capacity to on-board and/or surrounding UEs. The technical benefits of using vehicle relays include, among others, the ability of the relay vehicle to get better coverage than the nearby UE, thanks to better RF/antenna capabilities, thus providing the UE with a better link to the macro network. Additionally, a vehicle relay is expected to have less stringent power/battery constraints than the UEs.

As a VMR or a mobile IAB (mIAB) node may be static at some point (e.g. taxi in a car park or at a taxi rank, bus in a car park or at a bus stop, train at a station, or temporary installation at an event or emergency/disaster case) while moving otherwise, the connection with mobile IAB (mIAB) nodes, or Vehicle Mounted Relays (VMR), is likely to fluctuate based on their actual movement. Therefore, in order to take benefit of the extra connectivity resulting from the presence of a mobile IAB node in the topology while mitigating the connectivity impact that may result from its actual mobility status, the connection of a network device, or User Equipment (UE), to the network via or through such mobile IAB node should be managed carefully.

In this respect, in the context of mobile IAB, two kinds of UEs may be considered: 1) the surrounding UEs, referring to UEs connected to the mobile IAB node but which movement is not correlated to the mobile IAB node's movement (e.g. a smartphone used in the street nearby a bus station) and 2) on-board UEs (OB-UE), referring to UEs connected to the mobile IAB node and whose movement is similar to the mobile IAB node's movement. Therefore, an on-board UE is typically a UE that is located inside, or on, a vehicle fitted with a VMR or mobile IAB node (e.g. a smartphone used inside a bus or a train). Throughout the present specification, the term “on-board UE”, and references to a UE having an “on-board status” with respect to a given mobile IAB node, are used to indicate a situation in which the UE and mobile IAB node are associated with a same mobile vehicle (i.e. the mobile IAB node is associated with a vehicle, and the UE is associated with the same vehicle).

When a mobile IAB node is moving, an on-board UE should preferably keep its connection to the mobile IAB-node and not perform any handover or cell reselection towards some other stationary network (gNB or fixed IAB node) or towards some other mobile IAB-node equipped on another vehicle.

Therefore, it may be desirable for a given UE and/or a mobile IAB node and/or a donor CU to have some knowledge of the on-board status of said UE.

As a given IAB topology may, at some point, be made up of both legacy UE devices (belonging to former Releases 16 and 17), which do not have any ability to determine their on-board status, and more recent UE devices (belonging to Release 18 and further) having the ability to determine their on-board status, managing the on-board status of any kind of UE devices (e.g. legacy and recent UE devices) also needs to be taken into account.

Therefore, some new mechanisms are required to address at least some of the aforementioned issues, while limiting the complexity of the processing at a UE or an IAB-node or a donor CU as well as the latency that would result from such processing.

### SUMMARY

In accordance with a first aspect of the present invention, there is provided a method of determining, in a wireless network comprising a user equipment, UE, connected to a donor Integrated Access and Backhaul, IAB, node via a mobile Integrated Access and Backhaul, mIAB, node, an on-board status of the UE, the method comprising:
monitoring whether an on-board triggering condition is satisfied; and
determining that the UE has an on-board status when the on-board triggering condition is satisfied.

The step of monitoring whether an on-board triggering condition is satisfied may comprise comparing at least one on-board triggering quantity to an associated triggering threshold. The on-board triggering condition may be determined to be satisfied when at least one on-board triggering quantity is equal to or exceeds its associated triggering threshold for the duration of a predetermined on-board triggering period. The on-board triggering condition may be determined to be satisfied when at least one on-board triggering quantity is equal to or exceeds its associated triggering threshold for the duration of a predetermined on-board triggering period, while a mobility state of the UE indicates that the UE is moving. The mobility state may indicate a rate at which the UE is moving. In such cases, the on-board triggering condition may be determined to be satisfied when at least one on-board triggering quantity is equal to or exceeds its associated triggering threshold for the duration of a predetermined on-board triggering period, while the mobility state indicates that the rate at which the UE is moving is equal to or exceeds an on-board triggering speed. The mobility state of the UE may relate to a number of fixed cells detected by the UE in a predetermined period. The mobility state of the UE may relate to a number of fixed base stations detected by the UE in a predetermined period. The number of fixed cells and/or the number of fixed based stations detected by the UE may be determined based on one or more of the list comprising: reference signal received power, RSRP; reference signal received quality, RSRQ; signal-to-noise ratio, SNR; and a channel quality indicator, CQI. At least one on-board triggering quantity may comprise one or more of the list comprising: reference signal received power, RSRP; reference signal received quality, RSRQ; and signal-to-interference-plus-noise ratio, SINR.

The step of monitoring whether an on-board triggering condition is satisfied may comprise monitoring one or more measurement related to the radio link between the UE and the mIAB node.

The method may further comprise the step of:
after the UE has been determined to have an on-board status,
continuing to monitor whether an on-board triggering condition is satisfied; and
determining that the UE no longer has an on-board status when the on-board triggering condition is not satisfied.

The method may further comprise the steps of:
after the UE has been determined to have an on-board status with respect to a given mIAB node,
determining whether the UE is connected to said mIAB node; and
in a case where the UE is determined not to be connected to said mIAB node,
connecting the UE to said mIAB node.

The method according to the first aspect may be performed by the UE.

The method according to the first aspect may be performed by the mIAB.

The method according to the first aspect may be performed by the donor IAB node.

In accordance with a second aspect of the present invention, there is provided a method for use in managing network connectivity in a wireless communication system including a mobile Integrated Access and Backhaul, mIAB, node, the method at the mIAB node comprising:
generating or receiving an on-board notification message related to a user equipment, UE, the on-board notification message indicating an on-board status of the UE.

The method may further comprise:
receiving the on-board notification message from the UE or from a donor IAB node of the wireless communication system.

The method may further comprise:
generating the on-board notification message after determining the status based on an on-board monitoring configuration provided by a donor IAB node of the wireless communication system.

The method may further comprise:
generating the on-board notification message after determining the status based on measurements on the radio link between the UE and the mIAB node provided by the UE.

The method may further comprise sending to the donor IAB node a capability information message. The capability information message may contain an on-board monitoring configuration.

The method may further comprise the step of:
sending the generated on-board notification message to the UE and/or to a donor IAB of the wireless communication system.

In accordance with a third aspect of the present invention, there is provided a method for use in managing network connectivity in a wireless communication system including a mobile Integrated Access and Backhaul, mIAB, node, the method at a user equipment, UE, comprising:
generating or receiving an on-board notification message indicating an on-board status of the UE.

The method may further comprise:
receiving the on-board notification message from or via the mIAB node.

The method may further comprise:
generating the on-board notification message after determining the on-board status of the UE based on an on-board monitoring configuration provided by a donor IAB node of the wireless communication system.

The method may further comprise:
generating the on-board notification message after determining the on-board status of the UE based on measurements on the radio link between the UE and the mIAB node determined by the UE.

The method may further comprise the step of:
sending the on-board notification message to the mIAB node and/or to a donor IAB node of the wireless communication system.

The method may further comprise disabling a cell reselection process for the UE when the on-board notification message indicates that the UE has an on-board status.

The method may further comprise enabling a cell reselection process for the UE when the on-board notification message indicates that the UE does not have an on-board status.

In accordance with a fourth aspect of the present invention, there is provided a method for use in managing network connectivity in a wireless communication system including a donor Integrated Access and Backhaul, IAB, node, and an associated mobile IAB, mIAB, node, the method at the donor IAB node comprising:
generating or receiving on-board notification message related to a user equipment, UE, the on-board notification message indicating an on-board status of the UE.

The method may further comprise:
receiving the on-board notification message from or via the mIAB node.

The method may further comprise receiving from the mIAB node a capability information message. The capability information message may contain an on-board monitoring configuration

The method may comprise:
generating the on-board notification message after determining the status based on an on-board monitoring configuration.

The method may comprise:
generating the on-board notification message after determining the status based on measurements on the radio link between the UE and the mIAB node provided by the UE.

The method may further comprise the step of:
sending the on-board notification message to the UE and/or to the mIAB node.

The method may further comprise disabling a handover process involving the UE when the on-board notification message indicates that the UE has an on-board status.

The method may further comprise enabling a handover process involving the UE when the on-board notification message indicates that the UE does not have an on-board status.

The on-board monitoring configuration may comprise an on-board triggering condition, the UE having an on-board status when the on-board triggering condition is satisfied. The on-board triggering condition may be determined to be satisfied when at least one on-board triggering quantity is equal to or exceeds its associated triggering threshold. The on-board triggering condition may be determined to be satisfied when at least one on-board triggering quantity is equal to or exceeds its associated triggering threshold for the duration of a predetermined on-board triggering period. The on-board triggering condition may be determined to be satisfied when at least one on-board triggering quantity is equal to or exceeds its associated triggering threshold for the duration of a predetermined on-board triggering period, while a mobility state of the UE indicates that the UE is moving. The mobility state may indicate a rate at which the UE is moving. In such cases the on-board triggering condition may be determined to be satisfied when at least one on-board triggering quantity is equal to or exceeds its associated triggering threshold for the duration of a predetermined on-board triggering period, while the mobility state indicates that the rate at which the UE is moving is equal to or exceeds an on-board triggering speed. The mobility state of the UE may relates to a number of fixed cells detected by the UE in a predetermined period. The mobility state of the UE may relate to a number of fixed base stations detected by the UE in a predetermined period. The number of fixed cells and/or the number of fixed based stations detected by the UE may be determined based on one or more of the list comprising: reference signal received power, RSRP; reference signal received quality, RSRQ; signal-to-noise ratio, SNR; and a channel quality indicator, CQI. The on-board triggering speed may relate to a minimum number of fixed cells and/or fixed base stations detected by the UE during a predetermined time period. The predetermined time period may be the predetermined on-board triggering period.

At least one on-board triggering quantity may comprise one or more of the list comprising:
reference signal received power, RSRP;
reference signal received quality, RSRQ; and
signal-to-interference-plus-noise ratio, SINR.

In accordance with a fifth aspect of the present invention, there is provided a user equipment, UE, connectable to a donor Integrated Access and Backhaul, IAB, node via a mobile Integrated Access and Backhaul, mIAB, node, the UE comprising:
monitoring means configured to monitor whether an on-board triggering condition is satisfied; and
determination means configured to determine that the UE has an on-board status when the on-board triggering condition is satisfied.

In accordance with a sixth aspect of the present invention, there is provided a mobile Integrated Access and Backhaul, mIAB, node, configured to act as relaying node between a user equipment, UE, and a donor Integrated Access and Backhaul, IAB, node, the mIAB node comprising:
monitoring means configured to monitor whether an on-board triggering condition is satisfied; and
determination means configured to determine that the UE has an on-board status when the on-board triggering condition is satisfied.

In accordance with a seventh aspect of the present invention, there is provided a donor Integrated Access and Backhaul, IAB, node, configured to serve a user equipment, UE, via a mobile Integrated Access and Backhaul, mIAB, node, the donor IAB node comprising:
monitoring means configured to monitor whether an on-board triggering condition is satisfied; and
   determination means configured to determine that the UE has an on-board status when the on-board triggering condition is satisfied

In accordance with an eighth aspect of the present invention, there is provided a computer program comprising instructions which, when the program is executed by a computer, cause the computer to carry out the method according to any of the first to fourth aspects.

In accordance with a ninth aspect of the present invention, there is provided a computer-readable medium carrying a computer program according to the eighth aspect.

Any feature in one aspect of the invention may be applied to other aspects of the invention, in any appropriate combination. In particular, method aspects may be applied to apparatus/device/unit aspects, and vice versa.

Furthermore, features implemented in hardware may be implemented in software, and vice versa. Any reference to software and hardware features herein should be construed accordingly. For example, in accordance with other aspects of the invention, there are provided a computer program comprising instructions which, when the program is executed by a processing unit, cause the processing unit to carry out the method of any aspect or example described above and a computer readable storage medium carrying the computer program.

It should also be appreciated that particular combinations of the various features described and defined in any aspects of the invention can be implemented and/or supplied and/or used independently.

### BRIEF DESCRIPTION OF THE DRAWINGS

Different aspects of the invention will now be described, by way of example only, and with reference to the following drawings in which:

FIG. 1 is a schematic diagram illustrating an example wireless communication system in which the present invention may be implemented according to one or more embodiments;

FIGS. 2a and 2b are schematic diagrams illustrating stacks of some protocol layers involved in IAB operations;

FIG. 3 is a schematic diagram illustrating the format of a BAP Protocol Data Unit (PDU) or packet;

FIG. 4 is a block schematic diagram illustrating an example wireless communication system (or IAB network) in which the present invention may be implemented according to one or more embodiments;

FIG. 5, FIG. 6 and FIG. 7 are schematic and simplified diagrams illustrating example message flows for determining the on-board status of a UE and managing the connectivity of such UE in accordance with one or more embodiments of the invention;

FIG. 8 is a flowchart of an example method for determining by a wireless communication device the on-board status of a Network Device, or UE, according to one or more embodiments of the present invention.

FIG. 9 is a flowchart of an example method for determining by a UE its on-board status according to one or more embodiments of the present invention;

FIG. 10 is a flowchart of an example method for determining the on-board status of a UE at a mobile IAB node according to one or more embodiments of the present invention;

FIG. 11 is a flowchart of an example method for determining the on-board status of a UE at a Donor CU according to one or more embodiments of the present invention;

FIG. 12 is a flowchart of an example method for configuring on-board status monitoring and triggering conditions at a mobile IAB node according to one or more embodiments of the present invention;

FIG. 13a and FIG. 13b are flowcharts providing example methods for a UE to manage cell reselection based on its on-board status according to one or more embodiments of the present invention;

FIG. 14a and FIG. 14b are flowcharts providing example methods for managing the connectivity of a UE based on its on-board status at a Donor CU according to one or more embodiments of the present invention;

FIG. 15 shows a block schematic representation of a wireless communication device in accordance with embodiments of the present invention;

### DETAILED DESCRIPTION

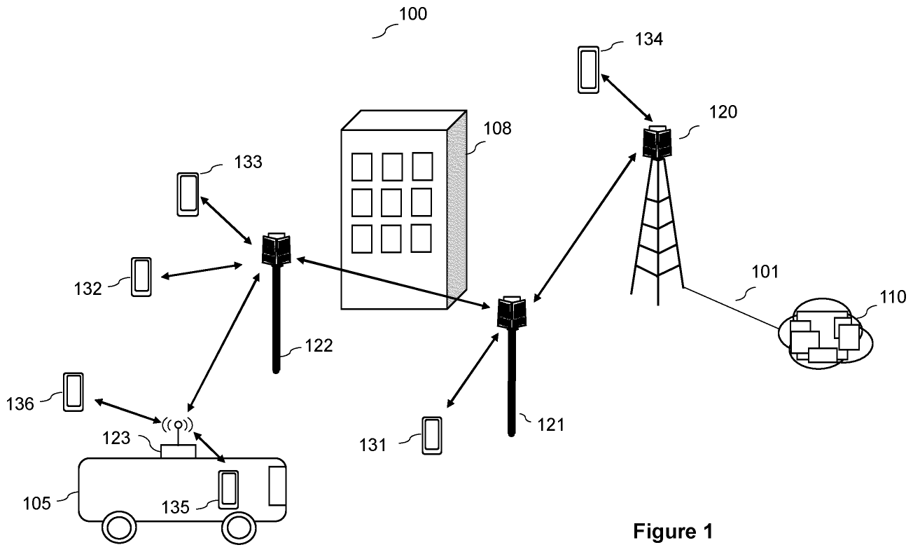

FIG. 1 illustrates an example communication system 100 in which the present invention may be implemented according to one or more embodiments.

As depicted, the example system 100 is a wireless communication system, in particular a mobile radio communication system such as a fifth-generation (5G) New Radio (NR) system including a wireless Integrated Access and Backhaul (IAB) communication system or network. Although in the following description, embodiments and examples of embodiments of the present invention will be described with respect to a 5G NR system, it will be appreciated that it is not intended that the present invention is limited to 5G NR systems and may be used in any wireless communication systems having an integrated access and backhaul communication system which shares radio resources for wireless access links and wireless backhaul links.

The system 100 comprises a plurality of UEs (User Equipment) 132, 133, 131 and 134, a remote core network 110, a main Base Station 120, two fixed Integrated Access and Backhaul (IAB) stations 121 and 122 or IAB nodes 121 and 122 (also referred to in the following as IAB-nodes) and a mobile Integrated Access and Backhaul (IAB) station or mobile IAB node 123 mounted on a vehicle 105 (for example, a bus, a train, a taxi, a car, etc.).

The main Base Station 120, also referred to as the IAB-donor 120 (or IAB donor), is connected to the core network 110 through a wired link 101, preferably an optical fiber or any other wired means. In embodiments and examples of embodiments of the invention, IAB-donor 120 is a 5G NR base station (referred to as a gNB) with additional functionality to support IAB features, as defined in 3GPP TS 38.300 v17.0.0 specification document.

In order to extend the network coverage of IAB-donor 120 and reach the remote UEs 132, 133 and 131, IAB stations 121 and 122, also referred to as IAB-nodes 121 and 122, have been installed by the operator. By acting as relaying nodes between the IAB-donor 120 and the UEs 132 and 133, IAB-nodes 121 and 122 allow overcoming the reachability issue resulting from presence of building 108, which is an obstacle to the propagation of radio waves and hence to the direct attachment and further communications between the UEs and the IAB-donor 120. This is particularly true when the communications between the IAB-donor 120 and UEs 132 and 133 are operated at millimeter wave frequencies, which are highly sensitive to shadowing phenomena.

The IAB-donor 120 also serves UE 134, which is directly connected to it.

The Mobile IAB station 123, also referred to as IAB-node 123 or mIAB node 123, which is mounted on vehicle 105, also provides network coverage and capacity extension, allowing the IAB-donor 120 to reach onboard remote UEs, like remote UE 135, as well as surrounding UEs or UEs in the vicinity of the IAB-node 123, like remote UE 136.

The IAB-donor 120 and the IAB-nodes 121, 122 and 123 are thus forming a backhaul network or IAB network (also referred to as IAB topology), which accommodates UEs 131, 132, 133, 134, 135 and 136. The terms IAB network and IAB topology will be used interchangeably in the following. The IAB network forms the Radio Access Network (RAN) or as referred to with respect to 5G, Next Generation (NG) RAN.

The specification of the Integrated Access and Backhaul (IAB) is spread over several 3GPP standard documents, including:
TS 38.300 RAN architecture (V17.0.0),
TS 38.321 MAC protocol (V17.0.0),
TS 38.331 Radio Resource Control (RRC) protocol (V17.0.0),
TS 38.340 Backhaul Adaptation Protocol Layer (V17.0.0),
TS 38.401 RAN architecture (V17.0.0),
TS 38.473 F1 Application Protocol (V17.0.0).

As IAB-nodes 121, 122 and 123 are respectively connected to UEs 131, 132, 133, 134, 135 and 136, they are considered as Access IAB-nodes for their respectively connected UEs.

The IAB-donor 120 is a logical node that provides the NR-based wireless backhaul and consists of a central unit (CU or gNB-CU functionality) and connected donor distributed unit(s) (DU or gNB-DU functionality). The IAB-donor-CU or donor CU (also referred to in the following as IAB-donor CU or IAB donor CU) hosts higher layer protocols, such as PDCP (Packet Data Convergence Protocol) and RRC (Radio Resource Control) protocols, for controlling operation of one or more DUs and each of the one or more IAB-donor-DUs or donor DUs (also referred to in the following as IAB-donor DU or IAB donor DU) includes lower layer protocols, such as the RLC, MAC and physical layer protocols. The IAB-donor CU and IAB-donor DU may be located far from the other or may be located in the same physical device. The gNB-DU functionality is defined in 3GPP TS 38.401. It aims at terminating the NR access interface to the UEs and next-hop IAB-nodes, and at terminating the F1 protocol to the IAB-donor gNB-CU functionality.

The IAB nodes, which may serve multiple radio sectors, are wireless backhauled to the IAB-donor 120, via one or multiple hops (e.g., via one or more IAB-nodes). They form a directed acyclic graph (DAG) topology with the IAB-donor at its root.

Each IAB node consists of an IAB-DU (IAB-Distributed Unit) and an IAB-MT (IAB-Mobile Termination). The gNB-DU functionality on an IAB-node is also referred to as IAB-DU and allows the downstream (toward the UE) connection to the next-hop IAB or to a UE.

The IAB-MT functionality includes, e.g., physical layer, layer-2, RRC and Non Access Stratum (NAS) functionalities to connect to the gNB-DU of an upstream IAB-node (including the IAB-donor 120 in which case it connects to the IAB-donor gNB-CU, hence to the core network 110, for instance for initialization, registration and configuration).

In this DAG topology, the neighbour node on the IAB-DU's interface is referred to as child node and the neighbour node on the IAB-MT's interface is referred to as parent node. The direction toward the child node is further referred to as downstream while the direction toward the parent node is referred to as upstream.

The IAB-donor 120 (e.g. the IAB-donor CU) performs centralized resource, topology and route management for the whole IAB topology. This includes configuring the IAB-nodes according to the network topology, e.g. in order to perform appropriate routing of data packets.

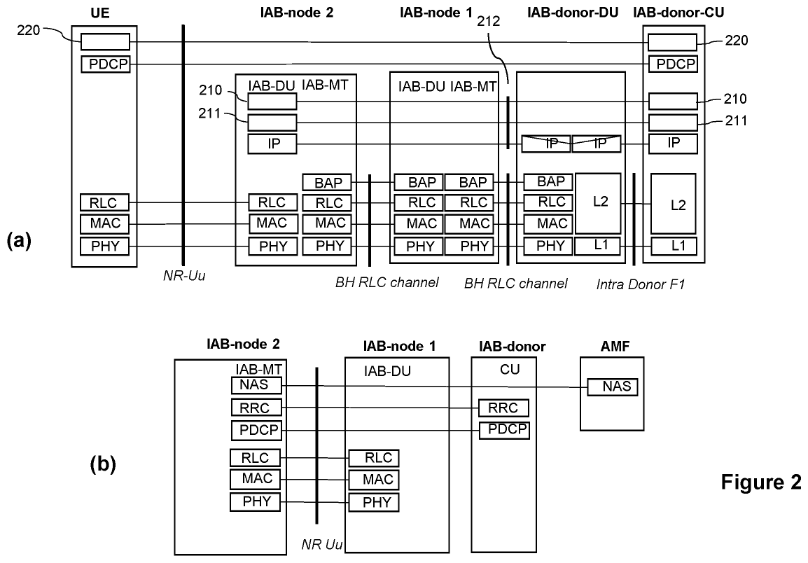

FIGS. 2a and 2b schematically illustrate stacks of some protocol layers involved in IAB operations.

F1 interface supports the exchange of signalling information between the endpoints, as well as the data transmission to the respective endpoints. From a logical standpoint, F1 interface is a point-to-point interface between the endpoints.

In 5G NR, F1-C is the functional interface in the Control Plane (CP) between the IAB-donor-CU and an IAB-node-DU. F1-U is the functional interface in the User Plane (UP) for the same units. F1-C and F1-U are shown by reference 212 in FIG. 2a. In this example, F1-U and F1-C are carried over two backhaul hops (from IAB-donor to IAB-node1 and then from IAB-node1 to IAB-node2).

In the User Plane, boxes 210 at the IAB-donor CU and the IAB-node DU refer to the GTP-U layer and boxes 211 refer to the UDP layer. GTP-U stands for GPRS Tunnelling Protocol User Plane. GTP-U Tunnels are used to carry encapsulated PDUs and signaling messages between a given pair of GTP-U Tunnel Endpoints (refer to 3GPP TS 29.281 for more details), here boxes 210 at the IAB-donor CU and the IAB-node DU. The well-known User Datagram Protocol (UDP) is a transport layer protocol providing a best effort datagram service and fit to use with an IP protocol.

In the Control Plane, boxes 210 indicate the F1AP (F1 Application Protocol) layer and boxes 211 indicate the SCTP (Stream Control Transmission Protocol) layer. The F1 Application Protocol (as defined in 3GPP TS 38.473 and TS 38.401) provides signalling services between the IAB-donor CU and the IAB-node DU, or UE associated services. These services are for example initialization, configuration, and so on. The well-known SCTP layer provides reliable, in sequence transport of messages with congestion control.

F1-U and F1-C rely on an IP transport layer between the IAB-donor CU and the IAB-node DU as defined in 3GPP TS 38.401.

The transport between the IAB-donor DU and the IAB-donor CU also uses an IP transport Layer over various media, like for example wires or optical fiber when the IAB-donor CU is remote from the IAB-donor DU, or locally in a virtual instantiation of the IAB-donor CU and the IAB-donor DU on the same physical machine. IAB-specific transport between IAB-donor-CU and IAB-donor-DU is specified in 3GPP TS 38.401.

L1 and L2 on the Figure stand respectively for the transport and physical layers appropriate to the medium in use.

The IP layer can also be used for non-F1 traffic, such as Operations, Administration and Maintenance traffic.

On the wireless backhaul, the IP layer is itself carried over the backhaul adaptation protocol (BAP) sublayer, which enables routing over multiple hops. The BAP sublayer is specified in TS 38.340.

The IAB-DU's IP traffic is routed over the wireless backhaul via the BAP sublayer. In a downstream direction, upper layer packets are encapsulated by the BAP sublayer at the IAB-donor DU, thus forming BAP packets or packet data units (PDUs) or data units. The BAP packets are routed by the BAP layer (and corresponding BAP entities in the IAB-DU and IAB-MT) of the intermediate IAB-nodes, if any. The BAP packets are finally de-encapsulated by the BAP sublayer at the destination IAB-node (which may be an access IAB-node should the upper layer packets in the BAP packets be intended for a UE).

In an upstream direction, upper layer packets are encapsulated by the BAP sublayer at an initiator IAB-node (which may be an access IAB-node should the upper layer packets come from a UE), thus forming BAP packets or PDUs or data units. The BAP packets are routed by the BAP layer (and corresponding BAP entities in the IAB-DU and IAB-MT) of the intermediate IAB-nodes, if any. The BAP packets are finally de-encapsulated by the BAP sublayer at the IAB-donor DU.

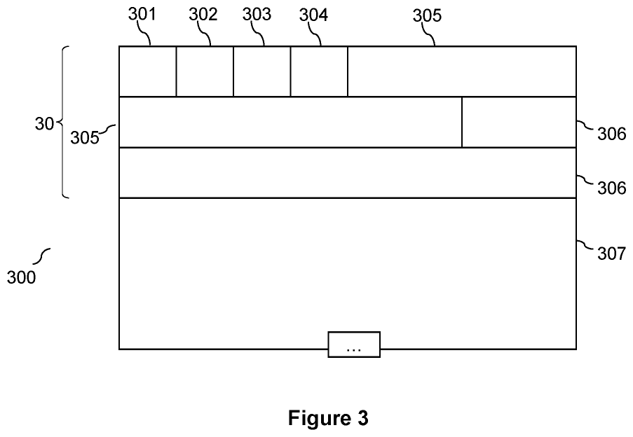

On the BAP sublayer, packets are routed based on the BAP routing ID, which is carried in the BAP header and which is set by the BAP sublayer of the network node in the IAB network generating the BAP packets. FIG. 3 illustrates the format of a BAP Data Protocol Data Unit (PDU) or packet. It is specified in the standardized version paragraph 6.2 of 3GPP TS38.340 release 17.0.0.

The header 30 includes fields 301 to 306. Field 301, named D/C field, is a Boolean indicating whether the corresponding BAP packet is a BAP Data packet or a BAP Control packet. Fields 302-304 are 1-bit reserved fields, preferably set to 0 (to be ignored by the receiver).

Fields 305 and 306 indicate together the BAP routing ID for the BAP packet. BAP address field 305, also referred to as DESTINATION field, is located in the leftmost 10 bits while BAP path identity field 306, also referred to as PATH field, is located in the rightmost 10 bits.

Field 305 carries the BAP address (i.e. on the BAP sublayer) of the destination IAB-node or IAB-donor DU for the BAP packet. For the purpose of routing, each IAB-node and IAB-donor DU is configured (by an IAB-donor CU which controls the IAB network or topology to which the IAB-node and IAB-donor DU belong) with a designated BAP address. Field 306 carries a path ID identifying the routing path the BAP packet should follow to this destination in the IAB topology. The routing paths, including their path IDs, are configured in the same way the BAP address is configured.

The BAP header is added to the packet when it arrives from upper layers to the BAP layer, and it is stripped off by the BAP layer when it has reached its destination node. The selection of the packet's BAP routing ID is configured by the IAB-donor-CU.

For instance, when the BAP packet is generated by an IAB-node, i.e. either by the IAB-donor for downstream transmission or by an initiator IAB-node for upstream transmission (which may be an access IAB-node should the upper layer packets come from a UE), the BAP header with the BAP Routing ID is built by this IAB-node according to a configuration table defined in 3GPP TS 38.340. This table is called Downlink Traffic to Routing ID Mapping Configuration table in the IAB-donor or Uplink Traffic to Routing ID Mapping Configuration table in the initiator IAB-node. In intermediate IAB-nodes, the BAP header fields are already specified in the BAP packet to forward.

As mentioned above, these configuration tables defining the BAP paths (hence the routing strategy and the configuration of the IAB-nodes given the IAB network topology) are usually defined by the IAB-donor-CU controlling the IAB network and transmitted to the IAB-nodes to configure them.

To process the transport of messages over the 5G NR radio medium, three more sublayers (RLC, MAC and PHY) are implemented at each IAB-node below the BAP sublayer. The RLC (Radio Link Control) sublayer is responsible for the segmentation or reconstruction of packets. It is also responsible for requesting retransmissions of missing packets. The RLC layer is further described in TS38.322. The MAC (Media Access Channel) protocol sublayer is responsible for selecting available transmission formats for the user data and for the mapping of logical channel to the transport channels. The MAC handles also a part of the Hybrid Automated Repetition request scheme. The MAC layer is detailed in TS 38.321. On the emitter side or transmitter side, the MAC encapsulates the data packet issued from the RLC. It adds a header carrying information necessary to the MAC function. On the receiver side, the MAC decapsulates the data packet issued from the PHY, deletes its header and passes the remaining data to the RLC. The PHY sublayer provides an electrical interface to the transmission medium (the air) by converting the stream of information into physical modulation signals, modulating a carrier frequency at the emitter side. At the receiver side the PHY sublayer converts the physical modulation signals back to a stream of information. The PHY layer is described in TS 38.201, TS 38.211, TS 38.212, TS 38.213, TS 38.214.

To pass messages towards the user or control plane, two other sublayers are used in the UE and IAB-donor-CU: the PDCP (Packet Data Convergence Protocol) sublayer and either the SDAP (Service Data Adaptation Protocol) sublayer for the User Plane communications or the RRC (Radio Resource Control) sublayer for the Control Plane communications.

The sublayer PDCP handles IP Header compression/decompression, ciphering/deciphering, and handles the integrity on the data packet if necessary. It mandatorily numbers the packets on the emitter side and reorders the packets on the receiver side. The PDCP sublayer is described in 3GPP TS38.323.

SDAP sublayer 220 for the User Plane handles the Quality of Service. It is described in TS38.324. On the UE side, the SDAP sublayer exchanges the payload data with the user's application (voice, video, etc. . . . —not shown in the Figure). On the IAB-donor side, the SDAP sublayer exchanges the data with the Core Network 110 (Internet traffic, Cloud, etc.).

RRC sublayer 220 for the Control Plane handles the configuration of the protocol entities of the User Plane protocol stack. It is described in TS38.331. It is responsible for the handling of, inter alia, broadcasting information necessary to a UE to communicate with a cell; transmitting paging messages, managing connection, including setting up bearers; mobility functions; measurement configuration and reporting; devices capabilities.

The interface (for both CP and UP) between nodes using the layers PDCP, RLC, MAC and PHY is referenced NR-Uu. This mainly concerns the interface with the UE.

The interface (for both CP and UP) between nodes using the layers BAP, RLC, MAC and PHY is named BackHaul RLC Channel (BH RLC channel). This mainly concerns the interfaces between the IAB-nodes.

NR-Uu is the interface between the UE and the radio access network, i.e. its access IAB-node (for both CP and UP).

FIG. 2b comes from 3GPP TS 38.300 v17.0.0 and illustrates the protocol stack for the support of IAB-MT's RRC and NAS connections. The Non-Access Stratum (NAS) protocol handles the messages between the core network and a user equipment, here an IAB-node. It manages the establishment of communication sessions and maintains communications with the user equipment as it moves. The 5G NAS is described in 3GPP TS 24.501. The 5G Core Access and Mobility Management Function (AMF) is a function within the Core Network that receives all connection and session related information from the UEs connected to the IAB node, as well as similar information for the IAB-node. AMF is only responsible for handling connection and mobility management tasks.

The IAB-MT establishes Signalling Radio Bearers SRBs (bearers carrying RRC and NAS messages) with the IAB-donor-CU. These SRBs are transported between the IAB-MT and its parent node(s) over NR-Uu interface(s).

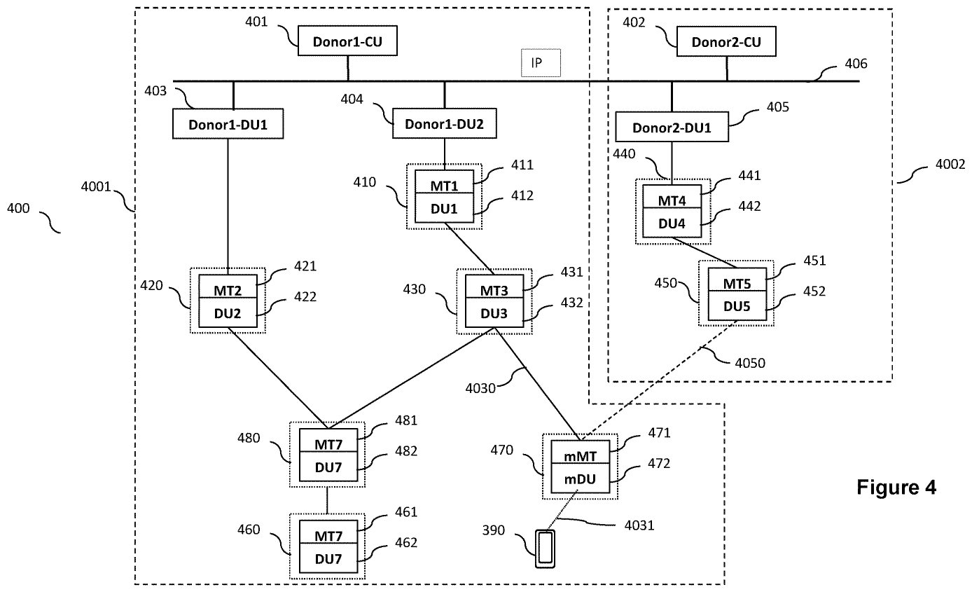

FIG. 4 illustrates an example of a wireless communication system 400, including an IAB network or IAB network system, in which embodiments and examples of embodiments of the present invention may be implemented. In one example implementation, the radio links between the IAB nodes and IAB donor DU nodes (referred to as BH radio links) are operated over the millimeter wave frequency band (i.e. above 30 GHz), which is highly sensitive to radio channel disturbance. An IAB network will also be referred to as an IAB topology or topology and so in this application, the terms IAB network and IAB topology and topology will be used interchangeably.

The IAB network system of FIG. 4, which forms part of the NG RAN, is composed of two IAB networks or IAB topologies 4001 and 4002 with each IAB topology comprising a set of IAB nodes (e.g. the set may comprise a plurality of IAB nodes or at least one IAB node) and a IAB-donor CU for controlling or managing the plurality of IAB nodes. The set of IAB nodes may include one or more IAB-nodes, such as initiator IAB-nodes which generate BAP packets and also intermediate or relay IAB-nodes. The set of IAB nodes may also include one or more IAB donor DUs. Each of the IAB nodes communicate with at least one other IAB node over a wireless backhaul (BH) link.

Although FIG. 4 shows two IAB topologies 4001 and 4002, the present invention is not limited to two IAB topologies 4001 and 4002 and may be implemented in an IAB communication system comprising more than two IAB topologies with each topology comprising a set of IAB nodes and an IAB donor CU as discussed above.

IAB topology 4001 includes IAB-donor-CU 401 (identified as Donor1-CU in FIG. 4), its associated IAB-donor-DUs, IAB-donor-DU 403 (identified as Donor1-DU1 in FIG. 4) and IAB-donor-DU 404 (identified as Donor1-DU2 in FIG. 4), and a plurality of IAB nodes 410, 420, 430, 460, 480, similar to IAB-nodes 121 and 122, and IAB-node 470, similar to mobile IAB-node 123.

IAB topology 4002 includes IAB-donor-CU 402 (identified as Donor2-CU in FIG. 4), and its associated IAB-donor-DU 405 (identified as Donor2-DU1 in FIG. 4), and a plurality of IAB-nodes 440 and 450, similar to IAB-nodes 121 and 122. The IAB network 400 can provide network path diversity through several IAB-donor-DUs and different IAB networks or topologies.

As discussed above, each IAB node comprises a Mobile Termination (MT) part or unit, controlled and configured by the IAB donor using RRC messaging as defined in 3GPP TS 38.331, and a Distributed Unit (DU) part, controlled and configured by the IAB donor using F1-AP messaging as defined in 3GPP TS 38.473. For example, IAB-node 410 comprises a MT part or unit 411 and a DU part 412.

A wired backhaul IP network interconnects the IAB-donor-CUs 401 and 402, and the IAB-donor-DUs 403, 404 and 405 through wired link 406. For instance, this wired link consists of optical fiber cable(s).

IAB-Donor-CU 401, IAB-Donor-DUs 403 and 404, IAB-nodes 410, 420, 430, 460, 470 and IAB-node 480 are part of the same IAB network or IAB topology 4001, which is controlled (e.g configured and/or managed) by IAB-Donor-CU 401.

IAB-Donor-CU 402, IAB-Donor-DU 405 and IAB-nodes 440 and 450 are part of the same IAB network or IAB topology 4002, which is controlled (e.g. configured and/or managed) by IAB-Donor-CU 402.

IAB-node 470 is connected to the parent IAB-node 430 through BH link 4030. IAB-node 470 is also connected to a UE 390 through communication link or radio link 4031: the IAB-node 470 is acting as an access node for UE 390. Although FIG. 4 shows only one UE 390, it will be appreciated that there will be a plurality of UEs connected to IAB nodes of the wireless communication system. Although IAB-node 470 belongs to IAB network 4001 (with IAB-node 430 as a parent through the BH link 4030), in view of its proximity to IAB network 4002 and in particular to IAB-node 450, IAB-node 470 may connect to IAB-node 450 (which would act as a parent node to IAB-node 470) through wireless BH link 4050. Such connection to IAB-node 450 in addition or in place of the connection to IAB-node 430 is possible for a stationary IAB-node, and it is very likely to happen for a mobile IAB-node, like IAB-node 470, moving, for instance, in the direction of the IAB topology 4002.

Each IAB-node supports wireless communication in a coverage area referred to as a cell. In other words, each IAB-node is associated with a cell. Wireless communication devices (such as UEs, or other IAB-nodes) located within the cell may connect to the IAB-node serving the cell in order to communicate with other devices (e.g. other UEs, IAB-nodes, servers providing access to the Internet, etc.) via the IAB-node. Typically, an IAB-node measures signals from IAB-node of adjacent cells as part of a cell search procedure (e.g. when initially connecting to the network as defined in 3GPP TS 38.300) or as part of a subsequent procedure. The measurements are reported to the IAB donor CU of the IAB-node. For example, with reference to FIG. 4, the IAB-node 470 may report to its IAB donor CU 401 the presence of a new cell served by IAB-node 450 through a measurement report. Based on the analysis of the measurement report (e.g. measurements in the report indicate the signal strength provided by the IAB-node 450 is above a threshold for supporting communications), the IAB donor CU 401 may request to the IAB donor CU 402, to which the IAB-node 450 belongs, the establishment of a dual connectivity for the IAB-node 470 with an additional connection through the IAB-node 450. The IAB donor CU 402 may accept the request and proceed to establish the connection of the IAB-node 470 to the IAB-node 450 according to the procedure described in TS 37.340 v17.0.0 section 10.2. As a result, the IAB-node 470, still belonging to IAB topology 4001, is now also connected to IAB-node 450, which belongs to IAB topology 4002, and so it may be referred to as a boundary node between IAB topology 4001 and IAB topology 4002. Actually, the IAB-node 470 retains its F1 connection and its RRC connection to the IAB donor CU 401, which can be referred to as the F1 terminating IAB-donor-CU, and it has a second RRC connection with the IAB donor CU 402, which can be referred to as the non-F1 terminating IAB-donor-CU. An IAB donor-CU that terminates a RRC connection of the IAB-node may be referred to as a RRC terminating donor-CU or RRC donor-CU. A RRC terminating donor-CU may be an F1 terminating donor-CU or a non-F1 terminating donor-CU.

As IAB-node or boundary node 470 is part of the IAB topology 4001 (from the F1 connection point of view), it is controlled (e.g. configured and/or managed) by the IAB-Donor-CU 401 of IAB topology 4001. Through the second RRC connection, the IAB donor CU 402, assigns a second BAP address to be used for routing packets through the IAB topology 4002. Thus, IAB-node 470 acting as a boundary node is assigned two BAP addresses: one BAP address for IAB network 4001 and one BAP address for IAB network 4002. Such a boundary node can help provide network path diversity by providing alternative routing paths through the IAB topologies 4001 and 4002.

As the IAB-node 470 is a mobile IAB-node (for example, it is mounted on a vehicle) the IAB-node 470 will not always be stationary and will move so that the connections to the IAB-nodes 430 and 450 may change over time. For example, if the movement of the IAB-node 470 is small such that the IAB-node 470 and IAB-nodes 430 and 450 are still close enough to each other to meet minimum requirements to support communication (e.g., signal strength is above a threshold), the connections with the IAB-nodes 430 and 450 may not change.

However, if the movement of the IAB-node 470 is such that the IAB-node 470 moves out of the cell associated with IAB-node 430 and/or out of the cell associated with IAB-node 450, the IAB-node 470 may lose connection with IAB-node 430 and/or IAB-node 450, respectively. In such a case, the connections to the IAB-node as the IAB-node's moves should be managed in order to avoid loss of service for wireless devices connected to the IAB-node 470 (e.g IAB-node 430 and UE 390 as shown in FIG. 4). For example, in order to ensure continuity of service, a handover procedure may be initiated so that the one or more connections of the IAB-node 470 within the IAB communication system (e.g., to IAB-node 430) are handed over to a different cell. In the case the IAB-node 470 is handed over to a cell in the IAB topology of IAB donor CU 402, the IAB-node 470 retains its F1 connection to the IAB donor CU 401, which can be referred to as the F1 terminating IAB-donor-CU, and the IAB-node 470 has a single RRC connection to the IAB donor CU 402, which can be referred to as the non-F1 terminating IAB-donor-CU or the RRC terminating IAB-donor-CU. As discussed in the introduction, using mobile IAB nodes helps to increase connectivity (e.g., capacity) in the wireless communication system but connection(s) to the mobile IAB node will need to be managed to account for the movement of the mobile IAB node.

UE 390 may be an on-board UE for mobile IAB 470, i.e., the movement of UE 390 is similar to mobile IAB 470's movement. For instance, on-board UE 390 may be a smartphone located inside, for example, a bus or a train to which the mobile IAB node 470 has been mounted.

As on-board UE 390 is moving along with mobile IAB node 470, it may be in the vicinity of other potential access IAB nodes, like fixed IAB nodes 460, 480, or 450. However, due to the mobility of IAB node 470, the link quality between on-board UE 390 and these potential access IAB nodes is likely to evolve rapidly. Therefore, UE 390 should preferably keep its connection to mobile IAB-node 470 and not perform any handover or cell reselection towards any potential access IAB nodes as long as it is an on-board UE 390 for mobile IAB node 470.

The processes for determining the on-board status of a UE along with managing its connectivity in a wireless communication system including one or more mobile IAB nodes will now be described according to some embodiments of the present invention.

In the following description, the terms speed, velocity and mobility state should be considered to be interchangeable.

Also, in the following description, the term speed, velocity or mobility state may designate the rate at which a UE moves.

In one aspect of the invention, the rate at which a UE moves may be defined as the ratio of distance to the time in which the distance was covered. In such case, the speed of a UE may be expressed, for instance, in meters per second or in miles per hour or kilometers per hour.

In one aspect of the invention, the rate at which a UE moves may be defined as the ratio of the number of detected, or the number of newly detected, fixed cells and/or associated fixed base stations (which may be fixed IAB-nodes), to the time during which the fixed cells were detected. In one example, a fixed cell is detected by a UE if the link quality level, or the signal strength, measured by the UE for a fixed cell is greater than a predefined threshold. In one example, the UE may consider a plurality of thresholds, allowing to define a plurality of speed/velocity/mobility state levels. In one aspect of the invention, the aforementioned one or more thresholds may be configured at the UE by Operations, Administration and Maintenance (OAM), or by its serving base station, through a configuration message. In one example, this configuration message may be the RRCReconfiguration message defined in 3GPP TS 38.331.

In one example, the link quality level, or the signal strength, measurements considered for IAB cell detection may include one or more of the following metrics: Reference Signal Received Power (RSRP), which provides a measure of the received power of the strongest reference signal from the considered cell; Reference Signal Received Quality (RSRQ), which provides a measure of the quality of the received reference signal from the considered cell, relative to the interference level in the cell; Signal-to-Noise Ratio (SNR), which provides a measure of the signal quality relative to the noise level in the cell and can be used to determine the strength of the signal from the considered cell; Channel Quality Indicator (CQI), which provides a measure of the quality of a received signal. In addition to the aforementioned metrics, other measurements such as cell identity, beamforming quality, and channel state information may also be considered for link quality level, or signal strength measurement.

In one aspect of the invention, the determination of the speed, velocity or mobility state of a UE may be performed by the UE itself, based on local cell measurements.

In one aspect of the invention, the determination of the speed, velocity or mobility state of a UE may be performed by the IAB donor serving the UE, provided that the UE is in a connected state, based on cell measurements shared by the UE. In one example, the cell measurements are shared by the UE through a MeasurementReport message defined in 3GPP TS 38.331.

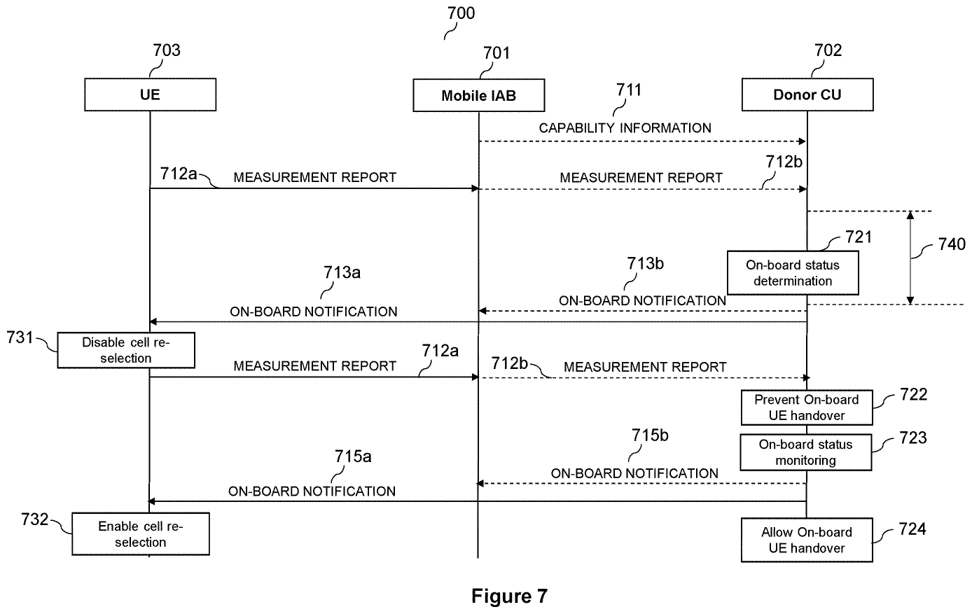

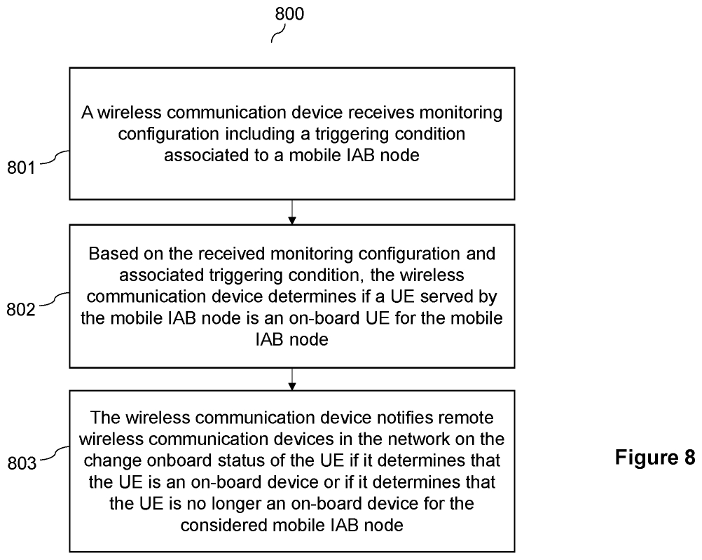

FIG. 8 is a flowchart of an example method for determining, by a wireless communication device, the on-board status of a Network Device, or UE, according to one or more embodiments of the present invention.

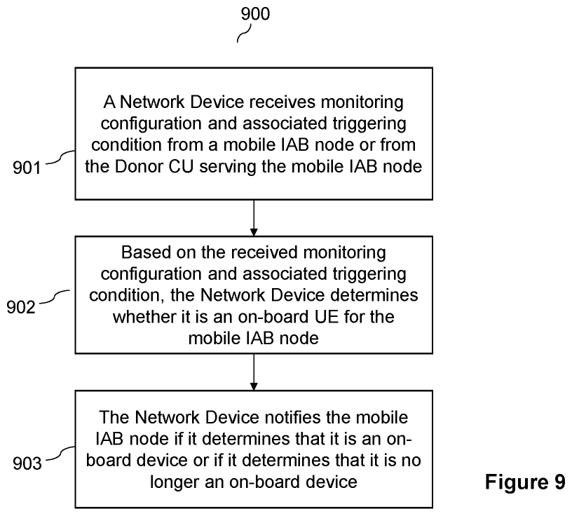

Details of this method when the determining wireless communication device is the Network Device, or UE, itself are provided in FIG. 9.

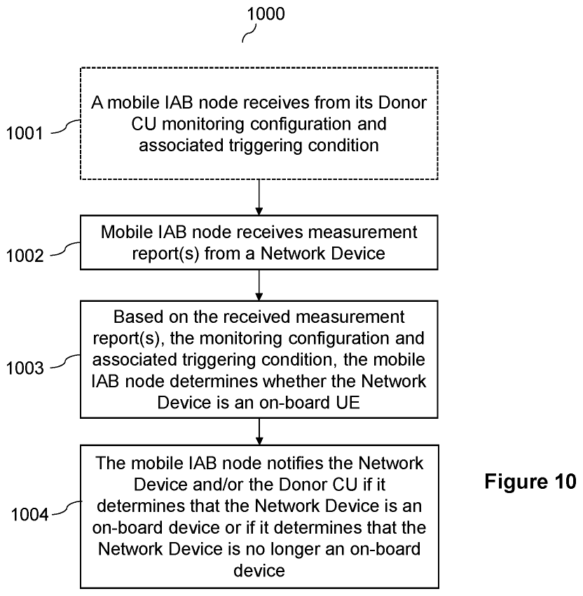

Details of this method when the determining wireless communication device is the mobile IAB node that is serving the Network Device, or UE, are provided in FIG. 10.

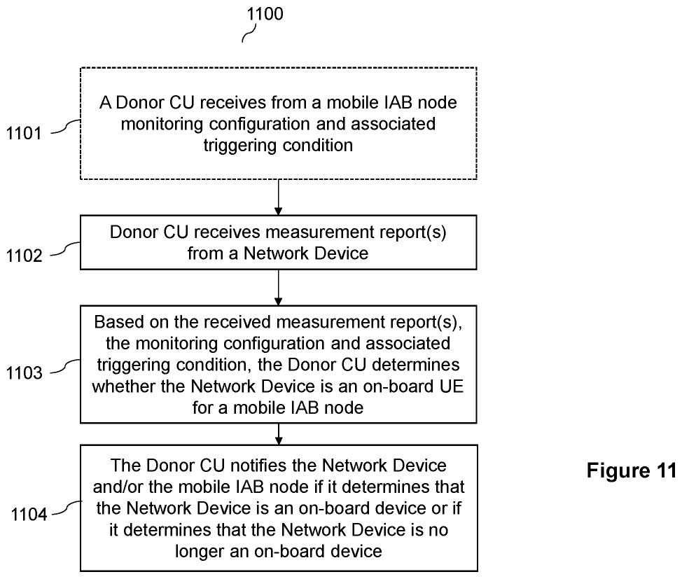

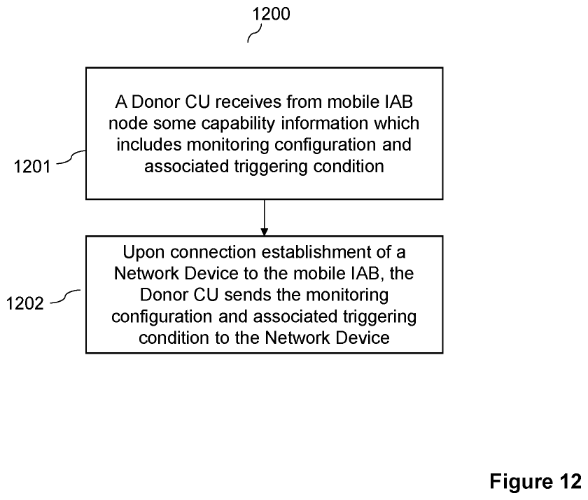

Details of this method when the determining wireless communication device is the donor CU that is serving the Network Device, or UE, are provided in FIG. 11.

For example, with reference to the wireless communication system shown in and described with respect to FIG. 4, the wireless communication devices performing the method 900 of FIG. 9, performed at the Network Device, or UE, the method 1000 of FIG. 10, performed at mobile IAB node, and the method 11 for FIG. 11, performed at donor CU, may be UE 390, mobile IAB node 470 and donor CU 401.

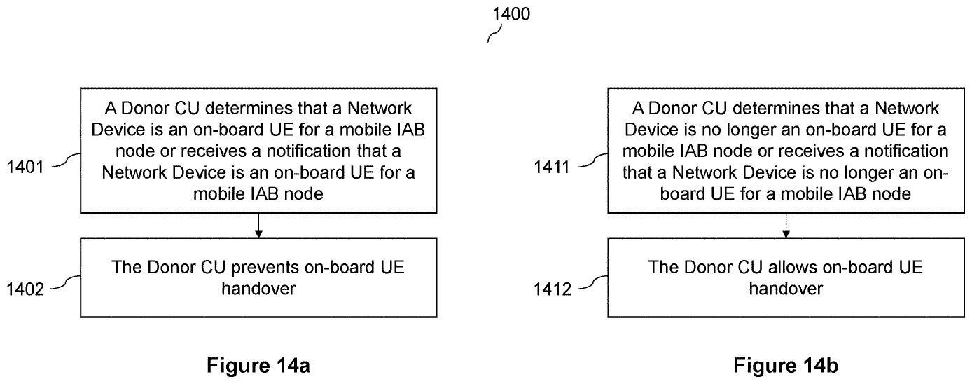

The method 900, 1000 and 1100 as shown in and described with respect to FIG. 9, FIG. 10 and FIG. 11, may be performed by software elements and/or hardware elements. The UE, the mobile IAB or the donor CU may be implemented in a communication device 1400 as shown in and described with reference to FIG. 14 with the method as shown in and described with respect to FIG. 14 being performed by one or more processing units, such as the central processing unit 1411.

Returning to FIG. 8, a wireless communication device may receive, at step 801, some on-board monitoring configuration including one or more triggering conditions, associated to a mobile IAB node and to be used for determining the on-board status of a UE served by the mobile IAB node. Thus, an on-board monitoring configuration may consist of one or more triggering condition(s), each triggering condition including at least one of: one or more trigger quantities (e.g. RSRP and RSRQ, RSRP and SINR, etc.) and associated triggering thresholds (the trigger quantities are associated to the radio link between the considered UE and the considered mobile IAB node); on-board UE triggering period; surrounding UE triggering period; on-board UE triggering speed. These one or more triggering condition(s) can be configured simultaneously for the evaluation of on-board conditions of a UE served by a mobile IAB node.

At step 802, the wireless communication device starts evaluating the on-board triggering condition(s) to determine if a UE served by the mobile IAB node is an on-board UE for this mobile IAB node.

In one embodiment of the invention, the wireless communication device may determine that the considered UE is an on-board UE for the considered mobile IAB node if at least one of the following on-board UE conditions are met:
One or more of the trigger quantities applied to the radio link between the considered UE and its serving mobile IAB node are above the associated triggering thresholds;
One or more of the trigger quantities applied to the radio link between the considered UE and its serving mobile IAB node are above the associated triggering thresholds for a time period which duration is greater than or equal to the on-board UE triggering period;
One or more of the trigger quantities applied to the radio link between the considered UE and its serving mobile IAB node are above the associated triggering thresholds for a time period which duration is greater than or equal to the on-board UE triggering period and the considered UE is moving during the considered time period (i.e., the speed of the considered UE is non-null or above a predefined threshold or above the on-board UE triggering speed);

In the present document, in one aspect of the invention, the evaluation of an on-board UE triggering period may be performed by monitoring a timer, which may be referred to as cell-dwelling timer.

In one embodiment of the invention, the wireless communication device may determine that the considered UE is a no longer an on-board UE for the considered mobile IAB node if at least one of the following conditions is met:
One or more of the trigger quantities applied to the radio link between the considered UE and its serving mobile IAB node are below the associated triggering thresholds;
One or more of the trigger quantities applied to the radio link between the considered UE and its serving mobile IAB node are below the associated triggering thresholds for a time period which duration is greater than or equal to the surrounding UE triggering period;

In one aspect of the invention, the monitoring of the aforementioned time period may be performed by monitoring the expiry of a dedicated timer, which may be referred to as a cell-dwelling timer.

At step 803, the wireless communication device may notify the remote wireless communication devices in the network on the change of the onboard status of the considered UE if it determines that the UE is an on-board device for the considered mobile IAB node or if it determines that the UE is no longer an on-board device for the considered mobile IAB node.

In case the wireless communication device performing the method 800 of FIG. 8 is the Network Device, or UE, itself, the UE would actually perform method 900 of FIG. 9.

Therefore, at step 901, a UE currently served by a mobile IAB node may receive some on-board monitoring configuration including one or more triggering conditions, as defined at step 801 of FIG. 8, associated to its serving mobile IAB node and to be used for determining its on-board status for its serving mobile IAB node.

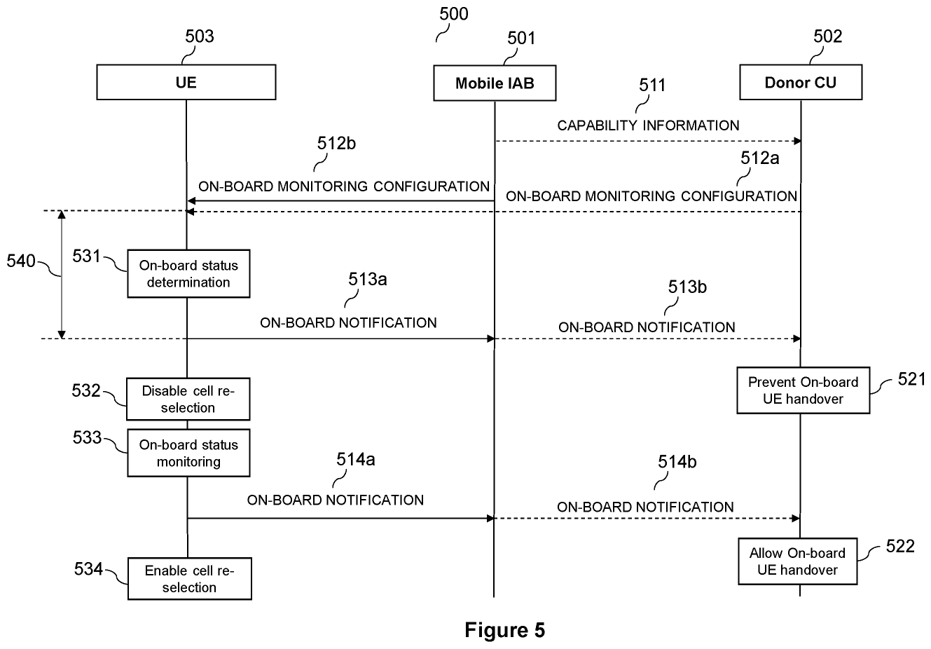

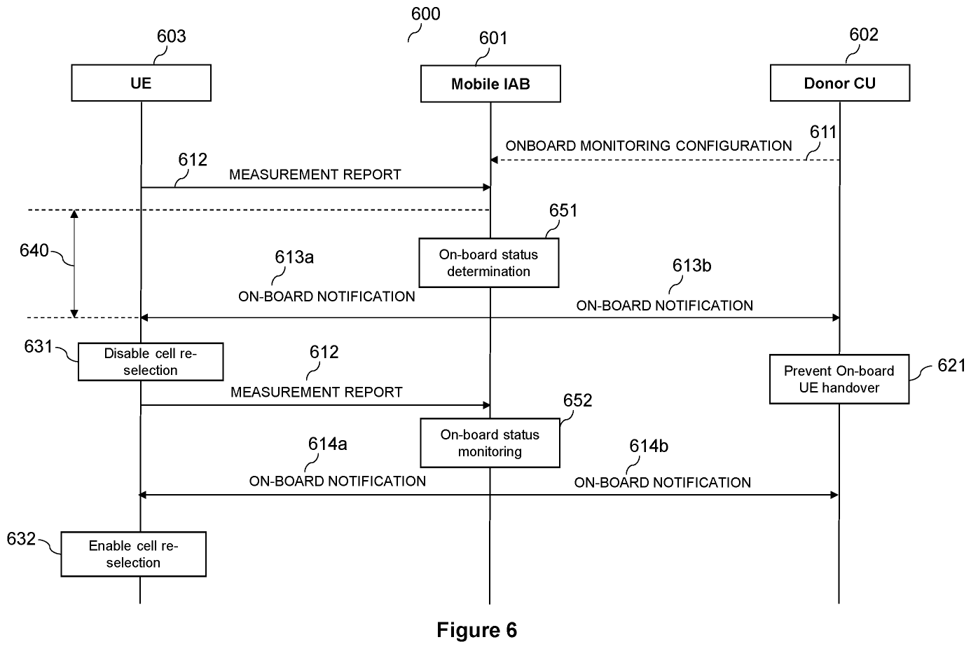

In one embodiment of the invention, the UE may receive the on-board monitoring configuration from its serving mobile IAB node within an on-board monitoring configuration message, such as ON-BOARD MONITORING CONFIGURATION message 512b, which is further described in FIG. 5.

In another embodiment of the invention, the UE may receive the on-board monitoring configuration from its serving donor CU within an on-board monitoring configuration message, such as ON-BOARD MONITORING CONFIGURATION message 512a, which is further described in FIG. 5.

At step 902, the UE device starts evaluating the on-board triggering condition(s) received at step 901 to determine if it is an on-board UE for its serving mobile IAB node. The UE device may determine that it is an on-board UE for its serving mobile IAB node if one or more of the conditions considered at step 802 are met.

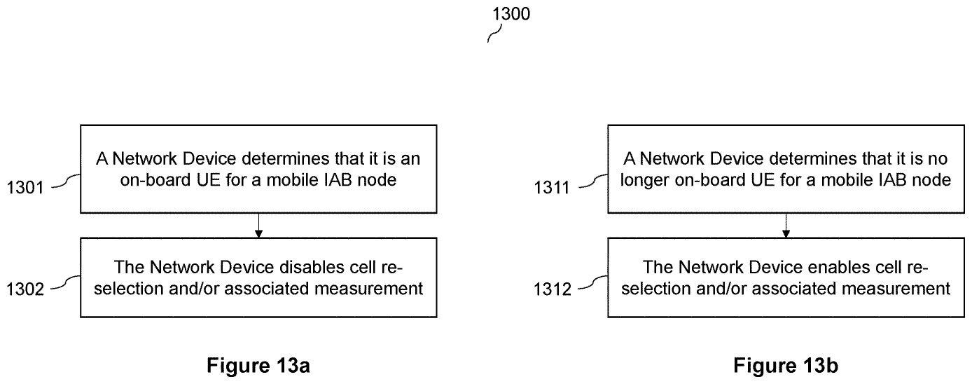

Considering step 1301 of FIG. 13a, in a case where the UE device determines that it is an on-board UE for its serving mobile IAB node, it may perform step 1302 and further disable cell-reselection and associated measurement reporting.

Indeed, in order to prevent service discontinuity that would result from the on-board UE device disconnecting from its mobile IAB node to transiently connect to a stationary network or another mobile IAB node to further re-connect with its former serving mobile IAB node for which it is onboard, an on-board UE in INACTIVE state may, in one aspect of the invention, disable its cell re-selection process by ignoring the measurements it performs with its surrounding fixed or mobile cells, except the one with its serving mobile IAB node for which it is on-board. In another aspect of the invention, an on-board UE in INACTIVE or CONNECTED state may stop monitoring its surrounding cells and performing measurements associated radio link measurements.

In one aspect of the invention, in step 1301, in case a UE device determines that it is an on-board UE for a given mobile IAB node, but is not camped on the mobile IAB-cell associated to this mobile IAB-node (e.g., the UE is camped on a stationary cell), the on-board UE may first perform cell reselection to the mobile IAB cell associated to the mobile IAB node for which the UE device determined it is on-board prior to performing step 1302.

Similarly, a UE that determines that it is an on-board UE for its serving mobile IAB node may keep on evaluating the on-board triggering condition(s) received at step 901 to determine whether its on-board status has changed or is still valid. The UE device may determine it is no longer an on-board UE for the considered mobile IAB node if at least one of the on-board UE conditions considered at step 802 is met.

Considering step 1311 of FIG. 13b, in a case where the UE device determines that it is no longer an on-board UE for its serving mobile IAB node, it may perform step 1312 and further enable cell-reselection and associated measurement reporting. In this respect, in one aspect of the invention, the UE may enable its cell re-selection process by resuming the monitoring of its neighbor cells, either fixed or mobile, along with the associated measurement reporting.

At step 903, the UE device may notify its serving mobile IAB node and/or its serving donor CU on the change of the onboard status of the considered UE if it determines that the UE is an on-board device for the considered mobile IAB node or if it determines that the UE is no longer an on-board device for the considered mobile IAB node.

In one embodiment of the invention, the UE may send to its serving mobile IAB node an on-board notification message, such as ON-BOARD NOTIFICATION message 513a or ON-BOARD NOTIFICATION message 514a, which are further described in FIG. 5.

In one embodiment of the invention, the UE may send to its serving donor CU an on-board notification message such as ON-BOARD NOTIFICATION message 513b or ON-BOARD NOTIFICATION message 514b, which are further described in FIG. 5.

In case the wireless communication device performing the method 800 of FIG. 8 is the mobile IAB node, the mobile IAB node would actually perform method 1000 of FIG. 10.

Therefore, at step 1001, the mobile IAB node may receive some on-board monitoring configuration including one or more triggering conditions, as defined at step 801 of FIG. 8, to be used for determining on-board status of its served UE devices.

In one aspect of the invention, the mobile IAB node may receive the on-board monitoring configuration from its donor CU within an on-board monitoring configuration message, such as ON-BOARD MONITORING CONFIGURATION message 611, which is further described in FIG. 6.

In another aspect of the invention, the on-board monitoring configuration is a factory setting or is configured at mobile IAB node through Operations, Administration and Maintenance (OAM) process.

Then, at step 1002, the mobile IAB node may receive from a served UE some measurement reports, via MEASUREMENT REPORT message 612, which is further described in FIG. 6, and provides information on the quality of the radio link between the mobile IAB node and the served UE. In one aspect of the invention, these measurements relate to the aforementioned trigger quantities (e.g. RSRP and RSRQ, RSRP and SINR, etc.).

At step 1003, based on the received measurement report(s), the monitoring configuration and the associated triggering condition(s), the mobile IAB node evaluates the on-board triggering condition(s) received at step 1001 to determine if the served UE is an on-board UE. The served UE device may be considered as an on-board UE by the serving mobile IAB node if at least one of the on-board UE conditions considered at step 802 is met.

Similarly, the mobile IAB node may keep on evaluating the on-board triggering condition(s) received at step 1001 based on newly received measurement reports to determine whether the on-board status of an on-board UE has changed. The mobile IAB node may determine that a UE is no longer an on-board UE if at least one of the surrounding UE conditions considered at step 802 is met.

At step 1004, the mobile IAB node may notify its served UE and/or its serving donor CU on the change of the onboard status of this served UE if it determines that the served UE is an on-board device or if the mobile IAB node determines that the served UE is no longer an on-board UE.

In one embodiment of the invention, the mobile IAB node may send to its served UE an ON-BOARD NOTIFICATION message 613a or an ON-BOARD NOTIFICATION message 614a, which are further described in FIG. 6.

In one embodiment of the invention, the mobile IAB node may send to its serving donor CU an ON-BOARD NOTIFICATION message 613b or an ON-BOARD NOTIFICATION message 614b, which is further described in FIG. 6.

In case the wireless communication device performing the method 800 of FIG. 8 is the donor CU, the donor CU would actually perform method 1100 of FIG. 11.

Therefore, at step 1101, the donor CU may receive some on-board monitoring configuration including one or more triggering conditions, as defined at step 801 of FIG. 8, associated to a served mobile IAB node and to be used for determining the on-board status for the UE devices served by this mobile IAB node.

In one aspect of the invention, the donor CU may receive the on-board monitoring configuration from its served mobile IAB node within a CAPABILITY INFORMATION message 711, which is further described in FIG. 7.

In another aspect of the invention, the on-board monitoring configuration is a factory setting or is configured at donor CU through Operations, Administration and Maintenance (OAM) process.

Then, at step 1102, the donor CU may receive from a served UE device via a mobile IAB node some measurement reports, via MEASUREMENT REPORT message 712b, which is further described in FIG. 7, and provides information on the quality of the radio link between the served UE and its serving mobile IAB node. In one aspect of the invention, these measurements relate to the trigger quantities (e.g. RSRP and RSRQ, RSRP and SINR, etc.) considered in the on-board monitoring configuration received at step 1001.

At step 1103, based on the received measurement report(s), the monitoring configuration and the associated triggering condition(s), the donor CU evaluates the on-board triggering condition(s) received at step 1101 to determine if the served UE is an on-board UE for its serving mobile IAB node. The served UE device may be considered as an on-board UE by the donor CU if at least one of the on-board UE conditions considered at step 802 is met.

In one embodiment of the invention, the donor CU may determine that a served UE is an on-board UE for its serving mobile IAB node by being notified of the on-board status of the served UE.

In one embodiment of the invention, the donor CU is notified of the on-board status of the served UE by receiving from the served UE an ON-BOARD NOTIFICATION message 513b, which is further described in FIG. 5, or by receiving from the mobile IAB node an ON-BOARD NOTIFICATION message 613b, which is further described in FIG. 6.

Considering step 1401 of FIG. 14a, in case the donor CU determines that the UE device is an on-board UE or in case the donor CU was notified that the UE device is an on-board UE, it may perform step 1402 and further prevent any potential handover of the on-board UE.

Indeed, in order to prevent service discontinuity that would result from the on-board UE device disconnecting from its mobile IAB node to transiently connect to a stationary network or another mobile IAB node to further re-connect with its former serving mobile IAB node for which it is onboard, the donor CU may prevent the handover of an on-board UE in CONNECTED state, thereby ignoring the measurements reports related to the surrounding fixed or mobile cells it may receive from the on-board UE (e.g. the donor CU may only consider the measurement report related to the cell of the mobile IAB node serving the on-board UE).

In one aspect of the invention, in step 1401, determines that the UE device is an on-board UE for a given mobile IAB node or in case the donor CU was notified that the UE device is an on-board UE for a given mobile IAB node, but said UE device is not connected to the mobile IAB-cell associated to the given mobile IAB-node (e.g., the UE device is connected to a stationary cell), the donor CU may perform the handover of the UE from its current serving cell to the mobile IAB-cell associated to the mobile IAB node for which the UE device determined it is on-board prior to performing step 1402.

Similarly, the donor CU may keep on evaluating the on-board triggering condition(s) received at step 1101 based on newly received measurement reports to determine whether the on-board status of an on-board UE has changed. The donor CU may determine that a UE is no longer an on-board UE if at least one of the surrounding UE conditions considered at step 802 is met.

In one embodiment of the invention, the donor CU may determine that a served UE is no longer an on-board UE for its serving mobile IAB node by being notified of the on-board status of the served UE.

In one embodiment of the invention, the donor CU is notified of the on-board status of the served UE by receiving from the served UE an ON-BOARD NOTIFICATION message 514b, which is further described in FIG. 5, or by receiving from the mobile IAB node an ON-BOARD NOTIFICATION message 614b, which is further described in FIG. 6.

Considering step 1411 of FIG. 14b, in case the donor CU determines that the UE device is no longer an on-board UE for its serving mobile IAB node, it may perform step 1412 and further authorize the handover process for the UE device, which is now considered as a surrounding UE for its serving mobile IAB node.

At step 1104, the donor CU may notify a served UE and/or the mobile IAB node serving said served UE device on the change of the onboard status of this served UE if it determines that the served UE is an on-board device or if the donor CU determines that the served UE is no longer an on-board UE.

In one embodiment of the invention, the donor CU may send to its served UE an ON-BOARD NOTIFICATION message 713a or an ON-BOARD NOTIFICATION message 715a, which are further described in FIG. 7.

In one embodiment of the invention, the donor CU may send to the mobile IAB node an ON-BOARD NOTIFICATION message 713b or an ON-BOARD NOTIFICATION message 715b, which is further described in FIG. 7.

Referring now also to FIG. 5 which is a schematic and simplified diagram illustrating example message flows for determining the on-board status of a UE and managing the connectivity of such UE in accordance with one or more embodiments of the invention.

According to an example, a mobile IAB node 501 (which may correspond to IAB node 123 of FIG. 1 and IAB node 470 of FIG. 4 as described above) may share some capability information with its IAB Donor 502 (which may correspond to IAB donor node 120 of FIG. 1 and IAB donor CU 401 of FIG. 4) by sending a capability information through a CAPABILITY INFORMATION message 511.

According to one example, this capability information sharing may be performed upon mobile IAB node 501 setup. According to another example, the capability information sharing may be performed at a predetermined time or in response to a predetermined condition. In this respect, it may be triggered by a change in the mobility status of the mobile IAB node 501 or may be performed on a periodic basis or may be performed upon request from the IAB Donor 502 (e.g. IAB donor CU 401).

In case the capability information sharing is performed upon mobile IAB node setup and according to one example, such capability information sharing is performed upon RRC connection establishment and the CAPABILITY INFORMATION message 511 is the RRCSetupComplete message used to complete the RRC connection establishment process, as specified in 3GPP TS 38.331.

In case the capability information sharing is performed upon mobile IAB node setup and according to another example, the aforementioned capability information sharing is performed as part of the F1 setup procedure and the CAPABILITY INFORMATION message 511 is the F1 SETUP REQUEST message, as specified in 3GPP TS 38.473.

In case the capability information sharing is performed on purpose and according to one example, the CAPABILITY INFORMATION message 511 is any one of the MeasurementReport, FailureInformation, IABOtherInformation or UEInformationResponse messages, as specified in 3GPP TS 38.331, or the GNB-DU CONFIGURATION UPDATE message, as specified in 3GPP TS 38.473.

According to one example, the CAPABILITY INFORMATION message 511 includes all or part of the following on-board monitoring configuration information (e.g. information used to determine and monitor the on-board status of a UE), which is also discussed in FIG. 8:
trigger quantities (e.g., RSRP and RSRQ, RSRP and SINR, etc.) and associated triggering thresholds. The trigger quantities are associated to the radio link between a UE and its serving mobile IAB node. This information is used to monitor the radio link quality between a UE and its serving mobile IAB node. This information may include one or more trigger quantities along with a triggering threshold for each of the trigger quantities. In one aspect of the invention, each of the trigger quantities should be considered and evaluated with regards to the associated triggering threshold when determining the on-board status of a UE device;
on-board UE triggering period, which defines a duration for evaluating the above one or more trigger quantities with regards to the associated triggering threshold. In one aspect of the invention, a UE device may be considered as an on-board UE if the above one or more trigger quantities are equal or greater than their associated triggering threshold for an on-board UE triggering period.
surrounding UE triggering period, which defines a duration for evaluating the above one or more trigger quantities with regards to the associated triggering threshold. In one aspect of the invention, a UE device may be considered as a surrounding UE (e.g. a UE device may be considered as no longer being an on-board UE) if the above one or more trigger quantities are less than their associated triggering threshold for a surrounding UE triggering period. In one aspect of the invention, the on-board UE triggering period has the same value as the surrounding UE triggering period. In another aspect of the invention, the on-board UE triggering period has a different value than the surrounding UE triggering period.
on-board UE triggering speed, which defines a minimum speed for the UE device to be considered when evaluating the above one or more trigger quantities with regards to the associated triggering threshold. In one example, the on-board UE triggering speed defines a minimum number of detected, or a minimum number of newly detected, fixed cells and/or associated fixed base stations, during a specific time period. In one example, this specific time period is equal to the on-board UE triggering period.

According to one example, the on-board UE triggering speed may be equal to a speed value associated to the mobile IAB node 501. In one aspect of the invention, the speed value associated to the mobile IAB node 501 may be a minimum speed value, or a maximum speed value, or an average speed value.

According to an example, once the UE device 503 (e.g., IAB node 470) has completed its connection setup process with the IAB Donor 502 (e.g. IAB donor CU 401) through the mobile IAB node 501, the IAB donor CU 502 may send the on-board monitoring configuration information it previously received from the mobile IAB node 501 by sending to the UE device an ON-BOARD MONITORING CONFIGURATION message 512a.

According to one example, the on-board monitoring configuration information sharing between the IAB donor CU 502 and the UE device 503 is performed through an RRC reconfiguration process and the ON-BOARD MONITORING CONFIGURATION message 512a is the RRCReconfiguration message specified in 3GPP TS 38.331.

ON-BOARD MONITORING CONFIGURATION message 512a is an example of the on-board monitoring configuration message discussed above with reference to FIG. 9.

According to an example, once the mobile IAB node 501 (e.g. IAB node 470) has completed its connection setup process with the IAB Donor 502 (e.g. IAB donor CU 401), the mobile IAB node 501 may provide or send (e.g. via broadcast), for advertising purpose, an ON-BOARD MONITORING CONFIGURATION message 512b, which includes the above on-board monitoring configuration information, to other wireless communication devices, like Network Device, or UE device, 503 in its vicinity.

This ON-BOARD MONITORING CONFIGURATION message 512b may be sent on a periodic basis.

In one aspect, the ON-BOARD MONITORING CONFIGURATION message 512b is the SIBI message, as defined in 3GPP TS 38.331.

ON-BOARD MONITORING CONFIGURATION message 512b is an example of the on-board monitoring configuration message discussed above with reference to FIG. 9.

Based on the on-board monitoring configuration information received through either ON-BOARD MONITORING CONFIGURATION message 512b or ON-BOARD MONITORING CONFIGURATION message 512a, the UE device 503 determines (step 531) its on-board status for its serving mobile IAB node 501.

In one example, the UE device may determine that it is an on-board UE for its serving mobile IAB node 501 if at least one of the following on-board UE conditions are met:
One or more of the trigger quantities, received in message 512a or 512b, applied to its radio link with its serving mobile node IAB 501 are equal or above the associated triggering thresholds;
One or more of the trigger quantities applied to its radio link with its serving mobile node IAB 501 are equal or above the associated triggering thresholds for a time period which duration is greater than or equal to the on-board UE triggering period 540;
One or more of the trigger quantities applied to its radio link with its serving mobile node IAB 501 are equal or above the associated triggering thresholds for a time period which duration is greater than or equal to the on-board UE triggering period 540 and the UE device 503 is moving during the considered time period. In one aspect of the invention, the UE device 503 is considered as a moving UE device if its speed is not null. In one aspect of the invention, the UE device 503 is considered as a moving UE device if its speed is equal or above a predefined threshold. In one aspect of the invention, the UE device 503 is considered as a moving UE device if its speed is above the on-board UE triggering speed. According to one example, the on-board UE triggering speed may be equal to a speed value associated to the mobile IAB node 501. In one aspect of the invention, the speed value associated to the mobile IAB node 501 may be a minimum speed value, or a maximum speed value, or an average speed value.

In one example, in case the UE device 503 determines that it is an on-board UE device for its serving mobile IAB node 501, it may send an ON-BOARD NOTIFICATION message 513a to its serving mobile IAB node 501 and/or an ON-BOARD NOTIFICATION message 513b to its serving IAB donor CU 502.

ON-BOARD NOTIFICATION message 513a and ON-BOARD NOTIFICATION message 513b are examples of the on-board notification messages discussed above with reference to FIG. 9.

In one aspect, the ON-BOARD NOTIFICATION message 513a is the measurement report message, defined in 3GPP TS 38.331, which may be forwarded as ON-BOARD NOTIFICATION message 513b to the IAB donor CU 502.

ON-BOARD NOTIFICATION message 513a or 513b may include all or part of the following information:
On-board UE status information, which indicates that the UE device 503 was determined as being an on-board device.

In one example, in case the UE device 503 determined at step 531 that it is an on-board UE for its serving mobile IAB node 501, it may further disable cell-reselection and associated measurement reporting. Indeed, in order to prevent service discontinuity that would result from the on-board UE device disconnecting from its mobile IAB node to transiently connect to a stationary network or another mobile IAB node to further re-connect with its former serving mobile IAB node for which it is onboard, an on-board UE in INACTIVE state may, in one aspect of the invention, disable its cell re-selection process by ignoring the measurements it performs with its surrounding fixed or mobile cells, except the one with its serving mobile IAB node for which it is on-board. In another aspect of the invention, an on-board UE in INACTIVE or CONNECTED state may stop monitoring its surrounding cells and performing measurements associated radio link measurements.

In one example, upon reception of an ON-BOARD NOTIFICATION message 513b from the UE device 503, the IAB donor CU 502 may further prevent, at step 521, any potential handover of the on-board UE device 503. Indeed, in order to prevent service discontinuity that would result from the on-board UE device 503 disconnecting from its mobile IAB node to transiently connect to a stationary network or another mobile IAB node to further re-connect with its former serving mobile IAB node 503 for which it is onboard, the donor CU may prevent the handover of the on-board UE 503 in CONNECTED state, thereby ignoring the measurements reports related to the surrounding fixed or mobile cells it may receive from the on-board UE device 503.

In one example, based on the on-board monitoring configuration information received through either ON-BOARD MONITORING CONFIGURATION message 512b or ON-BOARD MONITORING CONFIGURATION message 512a, an on-board UE device may keep on monitoring its on-board status in step 533 by performing the same monitoring process as the one described above in step 531.

In one example, UE device 503 may determine it is no longer an on-board UE for its serving mobile IAB node 501 (and is thus a surrounding UE for its serving mobile IAB node 501) if at least one of the following conditions is met:
One or more of the trigger quantities applied to its radio link with its serving mobile node IAB 501 are below the associated triggering thresholds;
One or more of the trigger quantities applied to its radio link with its serving mobile node IAB 501 are below the associated triggering thresholds for a time period which duration is greater than or equal to the surrounding UE triggering period;

In one example, in case the UE device 503 determines that it is no longer an on-board UE device for its serving mobile IAB node 501, it may send an ON-BOARD NOTIFICATION message 514a to its serving mobile IAB node 501 and/or an ON-BOARD NOTIFICATION message 514b to its serving IAB donor CU 502.

ON-BOARD NOTIFICATION message 514a and ON-BOARD NOTIFICATION message 514b are examples of the on-board notification messages discussed above with reference to FIG. 9.

In one aspect, the ON-BOARD NOTIFICATION message 514a is the measurement report message, defined in 3GPP TS 38.331, which may be forwarded as ON-BOARD NOTIFICATION message 514b to the IAB donor CU 502.

In one example, in case the UE device 503 determined that it is no longer an on-board UE for its serving mobile IAB node 501, it may enable cell-reselection and associated measurement reporting at step 534. In this respect, in one aspect of the invention, UE device 503 may enable its cell re-selection process by resuming the monitoring of its neighbor cells, either fixed or mobile, along with the associated measurement reporting to its serving mobile IAB node 501 or IAB donor CU 502.

In one example, upon reception of an ON-BOARD NOTIFICATION message 514b from the UE device 503, the IAB donor CU 502 may further authorize, at step 522, the handover process for the UE device 503, which is now considered as a surrounding UE for its serving mobile IAB node 501.

Referring now also to FIG. 6 which is a schematic and simplified diagram illustrating example message flows for determining the on-board status of a UE and managing the connectivity of such UE in accordance with one or more embodiments of the invention.

According to an example, a mobile IAB node 601 (which may correspond to IAB node 123 of FIG. 1 and IAB node 470 of FIG. 4 as described above) may receive some on-board monitoring configuration information from its IAB Donor CU 602 (which may correspond to IAB donor node 120 of FIG. 1 and IAB donor CU 401 of FIG. 4) through an ON-BOARD MONITORING CONFIGURATION message 611.

According to one example, the on-board monitoring configuration information sharing between the IAB donor CU 602 and the mobile IAB node 601 device is performed through an RRC reconfiguration process and the ON-BOARD MONITORING CONFIGURATION message 611 is the RRCReconfiguration message specified in 3GPP TS 38.331.

ON-BOARD MONITORING CONFIGURATION message 611 is an example of the on-board monitoring configuration message discussed above with reference to FIG. 10.

In one example of the invention, the on-board monitoring configuration information is a factory setting or is configured at mobile IAB node through Operations, Administration and Maintenance (OAM) process. In such case, the on-board monitoring configuration information is not received from the IAB donor CU.

In one example, the on-board monitoring configuration information considered in method 600 is the same as the on-board monitoring configuration information described in FIG. 5 in relation with message 511.

In one example, the mobile IAB node 601 may receive from served UE device 603 a MEASUREMENT REPORT message 612, which provides information on the quality of the radio link between the mobile IAB node 601 and the served UE device 603.

In one aspect, the MEASUREMENT REPORT message 612 is the measurement report message, defined in 3GPP TS 38.331.

MEASUREMENT REPORT message 612 is an example of the measurement report message discussed above with reference to FIG. 10.

In one example, the measurements included in MEASUREMENT REPORT message 612 relate to the trigger quantities (e.g. RSRP and RSRQ, RSRP and SINR, etc.) considered in the on-board monitoring configuration.

In one example, the measurements included in MEASUREMENT REPORT message 612 includes an information on the speed (e.g. minimum or average or maximum speed) of the UE device 603.

In one example, based on the aforementioned on-board monitoring configuration information, the mobile IAB node 601 device may determine at step 651 that its served UE device 603 is an on-board UE if at least one of the following on-board UE conditions are met:
Based on the information carried by the MEASUREMENT REPORT message 612 received from served UE device 603, one or more of the trigger quantities are equal or above the associated triggering thresholds;
Based on the information carried by the MEASUREMENT REPORT message 612 received from served UE device 603, one or more of the trigger quantities are equal or above the associated triggering thresholds for a time period which duration is greater than or equal to the on-board UE triggering period 640;
Based on the information carried by the MEASUREMENT REPORT message 612 received from served UE device 603, one or more of the trigger quantities are equal or above the associated triggering thresholds for a time period which duration is greater than or equal to the on-board UE triggering period 640 and the UE device 603 is moving during the considered time period. In one aspect of the invention, the UE device 603 is considered as a moving UE device if its speed is not null. In one aspect of the invention, the UE device 603 is considered as a moving UE device if its speed is equal or above a predefined threshold. In one aspect of the invention, the UE device 603 is considered as a moving UE device if its speed is above the on-board UE triggering speed. According to one example, the on-board UE triggering speed may be equal to a speed value associated to the mobile IAB node 601. In one aspect of the invention, the speed value associated to the mobile IAB node 601 may be a minimum speed value, or a maximum speed value, or an average speed value.

In one example, in case the mobile IAB node 601 determines that UE device 603 is an on-board UE, it may send an ON-BOARD NOTIFICATION message 613a to UE device 603 and/or an ON-BOARD NOTIFICATION message 613b to its serving IAB donor CU 602.

In one example, ON-BOARD NOTIFICATION message 613a or 613b may include all or part of the following information:
On-board UE status information, which indicates that the UE device 603 was determined as being an on-board device.

ON-BOARD NOTIFICATION message 613a and ON-BOARD NOTIFICATION message 613b are examples of the on-board notification messages discussed above with reference to FIG. 9.

In one aspect, the ON-BOARD NOTIFICATION message 613a is the RRCReconfiguration message, defined in 3GPP TS 38.331.

In one aspect, the ON-BOARD NOTIFICATION message 613b is any one of the MeasurementReport, FailureInformation, IABOtherInformation, UEassistanceInformation or UEInformationResponse messages, as specified in 3GPP TS 38.331, or the GNB-DU CONFIGURATION UPDATE message, as specified in 3GPP TS 38.473.

In one example, in case the UE device 603 receives an ON-BOARD NOTIFICATION message 613a which indicates that it is an on-board UE for its serving mobile IAB node 601, UE device 603 may further disable, at step 631, cell-reselection and associated measurement reporting. Indeed, in order to prevent service discontinuity that would result from the on-board UE device disconnecting from its mobile IAB node to transiently connect to a stationary network or another mobile IAB node to further re-connect with its former serving mobile IAB node for which it is onboard, an on-board UE in INACTIVE state may, in one aspect of the invention, disable its cell re-selection process by ignoring the measurements it performs with its surrounding fixed or mobile cells, except the one with its serving mobile IAB node for which it is on-board. In another aspect of the invention, an on-board UE in INACTIVE or CONNECTED state may stop monitoring its surrounding cells and performing measurements associated radio link measurements.

In one example, upon reception of an ON-BOARD NOTIFICATION message 613b from the mobile IAB node 601, the IAB donor CU 602 may further prevent, at step 621, any potential handover of the on-board UE device 603. Indeed, in order to prevent service discontinuity that would result from the on-board UE device 603 disconnecting from its mobile IAB node to transiently connect to a stationary network or another mobile IAB node to further re-connect with its former serving mobile IAB node 601 for which it is onboard, the donor CU 602 may prevent the handover of the on-board UE 603 in CONNECTED state, thereby ignoring the measurements reports related to the surrounding fixed or mobile cells it may receive from the on-board UE device 603.

In one example, based on the aforementioned on-board monitoring configuration information as well as newly received MEASUREMENT REPORT message(s) 612, a mobile IAB node 601 may keep on monitoring the on-board status of UE device 603 at step 652 by performing the same monitoring process as the one described above in step 651.

In one example, mobile IAB node 601 may determine that UE device 603 is no longer an on-board UE (and has thus become a surrounding UE) if at least one of the following conditions is met:
Based on the information carried by the MEASUREMENT REPORT message 612 received from served UE device 603, one or more of the trigger quantities are below the associated triggering thresholds;
Based on the information carried by the MEASUREMENT REPORT message 612 received from served UE device 603, one or more of the trigger quantities are below the associated triggering thresholds for a time period which duration is greater than or equal to the surrounding UE triggering period;

In one example, in case mobile IAB node 601 determines that UE device 603 is no longer an on-board UE device, it may send an ON-BOARD NOTIFICATION message 614a to UE device 603 and/or an ON-BOARD NOTIFICATION message 614b to its serving IAB donor CU 602.

In one example, ON-BOARD NOTIFICATION message 614a or 614b may include all or part of the following information:
Surrounding UE status information, which indicates that the UE device 603 was determined as being surrounding UE device.

ON-BOARD NOTIFICATION message 614a and ON-BOARD NOTIFICATION message 614b are examples of the on-board notification messages discussed above with reference to FIG. 10.

In one aspect, the ON-BOARD NOTIFICATION message 614a is the RRCReconfiguration message, defined in 3GPP TS 38.331.

In one aspect, the ON-BOARD NOTIFICATION message 614b is any one of the MeasurementReport, FailureInformation, IABOtherInformation, UEassistanceInformation or UEInformationResponse messages, as specified in 3GPP TS 38.331, or the GNB-DU CONFIGURATION UPDATE message, as specified in 3GPP TS 38.473.

In one example, in case UE device 603 receives an ON-BOARD NOTIFICATION message 614a, it may enable cell-reselection and associated measurement reporting at step 632. In this respect, in one aspect of the invention, UE device 603 may enable its cell re-selection process by resuming the monitoring of its neighbor cells, either fixed or mobile, along with the associated measurement reporting to its serving mobile IAB node 601 and/or IAB donor CU 602.

In one example, upon reception of an ON-BOARD NOTIFICATION message 614b from the mobile IAB node 601, the IAB donor CU 602 may further authorize, at step 621, the handover process for the UE device 603, which is now considered as a surrounding UE for its serving mobile IAB node 601.

Referring now also to FIG. 7 which is a schematic and simplified diagram illustrating example message flows for determining the on-board status of a UE and managing the connectivity of such UE in accordance with one or more embodiments of the invention.

According to an example, a mobile IAB node 701 (which may correspond to IAB node 123 of FIG. 1 and IAB node 470 of FIG. 4 as described above) may share some capability information with its IAB Donor 702 (which may correspond to IAB donor node 120 of FIG. 1 and IAB donor CU 401 of FIG. 4) by sending a capability information through a CAPABILITY INFORMATION message 711.

According to one example, this capability information sharing may be performed upon mobile IAB node 701 setup. According to another example, the capability information sharing may be performed at a predetermined time or in response to a predetermined condition. In this respect, it may be triggered by a change in the mobility status of the mobile IAB node 701 or may be performed on a periodic basis or may be performed upon request from the IAB Donor 702 (e.g. IAB donor CU 401).

In case the capability information sharing is performed upon mobile IAB node setup and according to one example, such capability information sharing is performed upon RRC connection establishment and the CAPABILITY INFORMATION message 711 is the RRCSetupComplete message used to complete the RRC connection establishment process, as specified in 3GPP TS 38.331.

In case the capability information sharing is performed upon mobile IAB node setup and according to another example, the aforementioned capability information sharing is performed as part of the F1 setup procedure and the CAPABILITY INFORMATION message 711 is the F1 SETUP REQUEST message, as specified in 3GPP TS 38.473.

In case the capability information sharing is performed on purpose and according to one example, the CAPABILITY INFORMATION message 711 is any one of the MeasurementReport, FailureInformation, IABOtherInformation, UEassistanceInformation or UEInformationResponse messages, as specified in 3GPP TS 38.331, or the GNB-DU CONFIGURATION UPDATE message, as specified in 3GPP TS 38.473.

According to one example, the CAPABILITY INFORMATION message 711 includes all or part of the following on-board monitoring configuration information (e.g. information used to determine and monitor the on-board status of a UE), which is the same as the on-board monitoring configuration information described in FIG. 5 in relation with message 511.

In one example of the invention, the on-board monitoring configuration information is a factory setting or is configured at IAB donor CU 702 through Operations, Administration and Maintenance (OAM) process. In such case, the on-board monitoring configuration information is not received from the mobile IAB node 701.

In one example, the mobile IAB donor CU 702 may receive from its served UE device 703, via the mobile IAB node 701, a MEASUREMENT REPORT message 712b, which provides information on the quality of the radio link between the mobile IAB node 701 and the served UE device 703.

In one aspect, the MEASUREMENT REPORT message 712a and 712b refer to the measurement report message, defined in 3GPP TS 38.331.

MEASUREMENT REPORT message 712a and 712b are examples of the measurement report message discussed above with reference to FIG. 11.

In one example, the measurements included in MEASUREMENT REPORT message 712b relate to the trigger quantities (e.g. RSRP and RSRQ, RSRP and SINR, etc.) considered in the on-board monitoring configuration.

In one example, the measurements included in MEASUREMENT REPORT message 712b includes an information on the speed (e.g. minimum or average or maximum speed) of the UE device 703.

In one example, based on the aforementioned on-board monitoring configuration information, the IAB donor CU 702 may determine at step 721 that its served UE device 703 is an on-board UE for mobile IAB node 701 if at least one of the following on-board UE conditions are met:
Based on the information carried by the MEASUREMENT REPORT message 712b received from served UE device 703, one or more of the trigger quantities are equal or above the associated triggering thresholds;
Based on the information carried by the MEASUREMENT REPORT message 712b received from served UE device 703, one or more of the trigger quantities are equal or above the associated triggering thresholds for a time period which duration is greater than or equal to the on-board UE triggering period 740;
Based on the information carried by the MEASUREMENT REPORT message 712b received from served UE device 703, one or more of the trigger quantities are equal or above the associated triggering thresholds for a time period which duration is greater than or equal to the on-board UE triggering period 740 and the UE device 703 is moving during the considered time period. In one aspect of the invention, the UE device 703 is considered as a moving UE device if its speed is not null. In one aspect of the invention, the UE device 703 is considered as a moving UE device if its speed is equal or above a predefined threshold. In one aspect of the invention, the UE device 703 is considered as a moving UE device if its speed is above the on-board UE triggering speed. According to one example, the on-board UE triggering speed may be equal to a speed value associated to the mobile IAB node 701. In one aspect of the invention, the speed value associated to the mobile IAB node 701 may be a minimum speed value, or a maximum speed value, or an average speed value.

In one example, in case the IAB donor CU 702 determines that UE device 703 is an on-board UE for mobile IAB node 701, it may send an ON-BOARD NOTIFICATION message 713a to UE device 703 and/or an ON-BOARD NOTIFICATION message 713b to mobile IAB node 701.

ON-BOARD NOTIFICATION message 713a or 713b may include all or part of the following information:
Surrounding UE status information, which indicates that the UE device 703 was determined as being surrounding UE device.

ON-BOARD NOTIFICATION message 713a and ON-BOARD NOTIFICATION message 713b are examples of the on-board notification messages discussed above with reference to FIG. 11.

In one aspect, the ON-BOARD NOTIFICATION message 713a is the RRCReconfiguration message, defined in 3GPP TS 38.331.

In one aspect, the ON-BOARD NOTIFICATION message 713b is the RRCReconfiguration message, defined in 3GPP TS 38.331.

In one example, in case the UE device 703 receives an ON-BOARD NOTIFICATION message 713a which indicates that it is an on-board UE for its serving mobile IAB node 701, UE device 703 may further disable, at step 731, cell-reselection and associated measurement reporting. Indeed, in order to prevent service discontinuity that would result from the on-board UE device disconnecting from its mobile IAB 701 node to transiently connect to a stationary network or another mobile IAB node to further re-connect with its former serving mobile IAB node 701 for which it is onboard, an on-board UE in INACTIVE state may, in one aspect of the invention, disable its cell re-selection process by ignoring the measurements it performs with its surrounding fixed or mobile cells, except the one with its serving mobile IAB node 701 for which it is on-board. In another aspect of the invention, an on-board UE in INACTIVE or CONNECTED state may stop monitoring its surrounding cells and performing measurements associated radio link measurements.

In one example, upon detection that the UE device 703 is an on-board device for mobile IAB node 701, the IAB donor CU 702 may further prevent, at step 722, any potential handover of the on-board UE device 703. Indeed, in order to prevent service discontinuity that would result from the on-board UE device 703 disconnecting from its mobile IAB node 701 to transiently connect to a stationary network or another mobile IAB node to further re-connect with its former serving mobile IAB node 701 for which it is onboard, the donor CU 702 may prevent the handover of the on-board UE 703 in CONNECTED state, thereby ignoring the measurements reports related to the surrounding fixed or mobile cells it may receive from the on-board UE device 703.

In case UE device 703 is a legacy device (i.e. a device compliant with 3GPP Release 17 specification or older) donor CU 702 may not send ON-BOARD NOTIFICATION message 713a as the UE device 703 may not be able to interpret it.

Still, the donor CU may advantageously manage the connectivity of this legacy UE device by enabling or disabling handover process for this device based on its on-board status with its serving mobile IAB node.

In one example, based on the aforementioned on-board monitoring configuration information as well as newly received MEASUREMENT REPORT message(s) 712, IAB donor CU 702 may keep on monitoring the on-board status of UE device 703 at step 723 by performing the same monitoring process as the one described above in step 721.

In one example, IAB donor CU 702 may determine that UE device 703 is no longer an on-board UE (and has thus become a surrounding UE) if at least one of the following conditions is met:
Based on the information carried by the MEASUREMENT REPORT message 712b received from served UE device 703, one or more of the trigger quantities are below the associated triggering thresholds;
Based on the information carried by the MEASUREMENT REPORT message 712b received from served UE device 703, one or more of the trigger quantities are below the associated triggering thresholds for a time period which duration is greater than or equal to the surrounding UE triggering period;

In one example, in case IAB donor CU 702 determines that UE device 703 is no longer an on-board UE device, it may send an ON-BOARD NOTIFICATION message 715a to UE device 703 and/or an ON-BOARD NOTIFICATION message 715b to its serving mobile IAB node 701.

ON-BOARD NOTIFICATION message 715a and ON-BOARD NOTIFICATION message 715b are examples of the on-board notification messages discussed above with reference to FIG. 11.

In one aspect, the ON-BOARD NOTIFICATION message 715a is the RRCReconfiguration message, defined in 3GPP TS 38.331.

In one aspect, the ON-BOARD NOTIFICATION message 715b is the RRCReconfiguration message, defined in 3GPP TS 38.331.

In one example, in case UE device 703 receives an ON-BOARD NOTIFICATION message 715a, it may enable cell-reselection and associated measurement reporting at step 732. In this respect, in one aspect of the invention, UE device 703 may enable its cell re-selection process by resuming the monitoring of its neighbor cells, either fixed or mobile, along with the associated measurement reporting to its serving mobile IAB node 701 and/or IAB donor CU 702.

In one example, upon detection that the UE device 703 is no longer an on-board UE for mobile IAB node 701, the IAB donor CU 702 may further authorize, at step 724, the handover process for the UE device 703, which is now considered as a surrounding UE for its serving mobile IAB node 701.

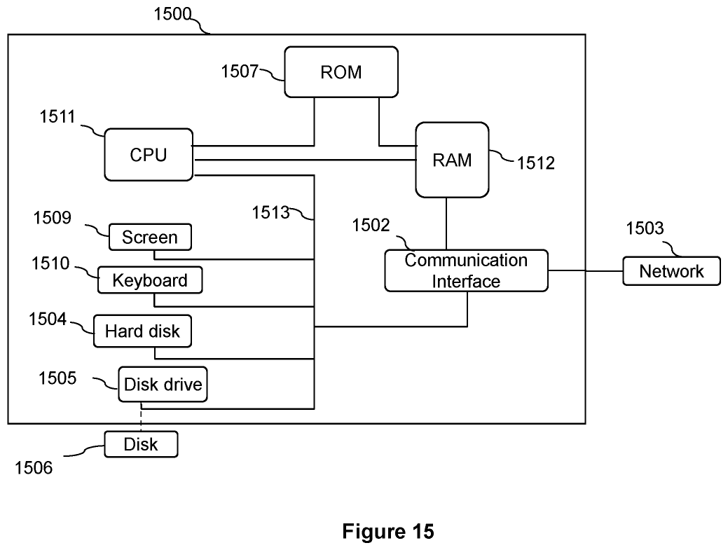

FIG. 15 shows a schematic representation of an example communication device (apparatus) or station, in accordance with one or more example embodiments of the present disclosure.

The communication device 1500 may be a device such as a micro-computer, a workstation or a light portable device. The communication device 1400 may comprise a communication bus 1513 to which there are connected:
a central processing unit 1511, such as a microprocessor, denoted CPU. The central processing unit 1511 may be a single processing unit or processor or may comprise two or more processing units or processors carrying out the processing required for the operation of the communication device 1500. The number of processors and the allocation of processing functions to the central processing unit 1511 is a matter of design choice for a skilled person;
memory for storing data and computer programs containing instructions for the operation of the communication device 1500. The computer programs may contain a number of different program elements (modules) or sub-routines containing instructions for a variety of operations and for implementing the methods in accordance with one or more embodiments of the invention; and
at least one communication interface 1502 for communicating with other devices or nodes in a wireless communication system, such as the wireless communication system of FIG. 1 or FIG. 4. The at least one communication interface 1502 may be connected to the radio communication network 1503, such as a wireless communication network for 5G NR (e.g. according to the release 16 and/or subsequent releases), over which digital data packets or frames or control frames are transmitted. The frames are written from a FIFO sending memory in RAM 1512 to the communication interface for transmission or are read from the communication interface for reception and writing into a FIFO receiving memory in RAM 1512 under the control of a software application running in the CPU 1511.

Each of a donor CU, a donor DU, an IAB node and a UE may comprise such a communication device 1500.

The memory may include:
a read only memory 1507, denoted ROM, for storing computer programs for implementing the methods in accordance with one or more embodiments of the invention;
a random-access memory 1512, denoted RAM, for storing the executable code of methods according to one or more embodiments of the invention as well as the registers adapted to record variables and parameters necessary for implementing methods according to one or more embodiments of the invention.

Optionally (and according to function of the communication device), the communication device 1500 may also include the following components:
a data storage means 1504 such as a hard disk, for storing computer programs for implementing methods according to one or more embodiments of the invention;
a disk drive 1505 for a disk 1506, the disk drive being adapted to read data from the disk 1506 or to write data onto said disk;
a screen 1509 for displaying decoded data and/or serving as a graphical interface with the user, by means of a keyboard 1510 or any other input/output means.

In an example arrangement, the communication bus provides communication and interoperability between the various elements included in the communication device 1500 or connected to it. The representation of the bus is not limiting and in particular, the central processing unit is operable to communicate instructions to any element of the communication device 1500 directly or by means of another element of the communication device 1500.

The disk 1506 may optionally be replaced by any information medium such as for example a compact disk (CD-ROM), rewritable or not, a ZIP disk, a USB key or a memory card and, in general terms, by an information storage means that can be read by a microcomputer or by a microprocessor, integrated or not into the communication device, possibly removable and adapted to store one or more programs whose execution enables a method according to embodiments of the invention to be implemented.

The executable code may optionally be stored either in read only memory 1507, on the hard disk 1504 or on a removable digital medium such as for example a disk 1506 as described previously. According to an optional variant, the executable code of the programs can be received by means of the communication network 1503, via the interface 1502, in order to be stored in one of the storage means of the communication device 1500, such as the hard disk 1504, before being executed.

The central processing unit 1511 may be adapted to control and direct the execution of the instructions or portions of software code of the program or programs according to embodiments of the invention, which instructions are stored in one of the aforementioned storage means. On powering up, the program or programs that are stored in a non-volatile memory, for example on the hard disk 1504 or in the read only memory 1507, are transferred into the random-access memory 1512, which then contains the executable code of the program or programs, as well as registers for storing the variables and parameters necessary for implementing the invention.

In an example implementation, the communication device (apparatus) is a programmable device/apparatus which uses software to implement the invention. Instructions may be executed by one or more processors, such as one or more digital signal processors (DSPs), general purpose microprocessors, application specific integrated circuits (ASICs), field programmable logic arrays (FPGAs), or other equivalent integrated or discrete logic circuitry. Accordingly, the term “central processing unit” as used herein may refer to any of the foregoing structure or any other structure suitable for implementation of the techniques described herein. However, alternatively, the present invention may be implemented in hardware (for example, in the form of an Application Specific Integrated Circuit or ASIC or other logic element).

While the present invention has been described with reference to embodiments, it is to be understood that the invention is not limited to the disclosed embodiments. It will be appreciated by those skilled in the art that various changes and modification might be made without departing from the scope of the invention, as defined in the appended claims. All of the features disclosed in this specification (including any accompanying claims, abstract and drawings), and/or all of the steps of any method or process so disclosed, may be combined in any combination, except combinations where at least some of such features and/or steps are mutually exclusive. Each feature disclosed in this specification (including any accompanying claims, abstract and drawings) may be replaced by alternative features serving the same, equivalent or similar purpose, unless expressly stated otherwise. Thus, unless expressly stated otherwise, each feature disclosed is one example only of a generic series of equivalent or similar features.

In the claims, the word “comprising” does not exclude other elements or steps, and the indefinite article “a” or “an” does not exclude a plurality. The mere fact that different features are recited in mutually different dependent claims does not indicate that a combination of these features cannot be advantageously used.

In the preceding embodiments, the functions described may be implemented in hardware, software, firmware, or any combination thereof. If implemented in software, the functions may be stored on or transmitted over, as one or more instructions or code, a computer-readable medium and executed by a hardware-based processing unit.

Computer-readable media may include computer-readable storage media, which corresponds to a tangible medium such as data storage media, or communication media including any medium that facilitates transfer of a computer program from one place to another, e.g., according to a communication protocol. In this manner, computer-readable media generally may correspond to (1) tangible computer-readable storage media which is non-transitory or (2) a communication medium such as a signal or carrier wave. Data storage media may be any available media that can be accessed by one or more computers or one or more processors to retrieve instructions, code and/or data structures for implementation of the techniques described in this disclosure. A computer program product may include a computer-readable medium.

By way of example, and not limitation, such computer-readable storage media can comprise RAM, ROM, EEPROM, CD-ROM or other optical disk storage, magnetic disk storage, or other magnetic storage devices, flash memory, or any other medium that can be used to store desired program code in the form of instructions or data structures and that can be accessed by a computer. Also, any connection is properly termed a computer-readable medium. For example, if instructions are transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. It should be understood, however, that computer-readable storage media and data storage media do not include connections, carrier waves, signals, or other transient media, but are instead directed to non-transient, tangible storage media. Disk and disc, as used herein, includes compact disc (CD), laser disc, optical disc, digital versatile disc (DVD), floppy disk and Blu-ray disc, where disks usually reproduce data magnetically, while discs reproduce data optically with lasers. Combinations of the above should also be included within the scope of computer-readable media.

The present invention covers also the following description:

### 1. Regarding Onboard UE Detection:

In RAN2 #119bis, RAN2 observed that a UE could potentially consider itself onboard of a mobile-IAB cell, if the UE camps on/connects to a mobile IAB cell during a long period (i.e., the UE then need to know that this is such a cell).

Considering the mobile nature of both the UE and the mobile IAB node it is onboard, which are further discussed here, having an onboard UE camping on a mobile IAB cell implies that an onboard UE may be defined as a UE moving together with a mobile IAB node.

One method to assess that a UE and a mobile IAB node are moving together is to monitor the signal strength measured by the considered UE with its serving mobile IAB cell. In this respect, some RSRP measurement may be considered. Having the measured signal strength remaining above a minimum threshold for a minimum period of time may indicate that the UE is likely to be an onboard UE for the mobile IAB-node.

Similarly, an onboard UE having the signal strength (e.g., RSRP) with its serving mobile IAB cell being less than a minimum threshold for a minimum time period may be considered as a surrounding UE (i.e., the UE is no longer considered as an onboard UE).

Therefore, it may be proposed that an onboard UE is defined as a UE moving together with a mobile IAB node/mobile IAB cell.

It may also be proposed that a UE is considered as moving together with a mobile IAB node/mobile IAB cell if the signal strength (e.g., RSRP) with the mobile IAB cell remains above a minimum threshold for a minimum period of time.

It may also be proposed that a UE is no longer considered as an onboard UE if the signal strength (e.g., RSRP) with a mobile IAB cell remains below a minimum threshold for a minimum period of time.

Still, performing the onboard UE detection based on some cell measurement may not be sufficient, as some static UE may be considered as an onboard UE for a static mobile IAB node in case the onboard monitoring time period is not long enough. For instance, the mobile phone of a person waiting for train #A may be considered as an onboard UE for train #B in case train #B remains static at the train station for a too long period.

Therefore, in order to prevent wrong onboard UE detection, only the UEs having a significant speed, i.e., a speed above a minimum threshold, may be considered as onboard UEs. In this respect, a UE may be detected, or may detect itself, as an on-board UE for a given mobile IAB cell once the following conditions are met:
The signal strength with the considered mobile IAB cell has been above a minimum threshold for a minimum period of time (proposal 1b);
The UE is moving at a minimum speed.

Therefore, it may be proposed that in order to prevent wrong onboard UE detection, a UE may be considered as an on-board UE for a given mobile IAB cell once, i.e. when, the following conditions are met:
The signal strength with the considered mobile IAB cell has been above a minimum threshold for a minimum period of time (as stated in proposal 1b);
The UE is moving at a minimum speed.

### 2. Regarding Onboard UE Detection Cell Reselection for Onboard UEs:

As long as a mobile IAB node is moving, an onboard UE should preferably keep its connection to the mobile IAB-node and not perform cell reselection or be handed over towards some other stationary network (gNB or fixed IAB node) or towards some other mobile IAB node equipped on another vehicle passing by in the vicinity.

In particular, in order to prevent service discontinuity that would result from the onboard UE device disconnecting from its mobile IAB node and associated mobile IAB cell to transiently connect to a stationary network or to some other mobile IAB cell in the vicinity, an onboard UE in IDLE/INACTIVE state may no longer perform any cell reselection and associated neighbouring cell measurements as long as it remains onboard for the considered mobile IAB node.

Similarly, in a case where a UE determines that it is no longer an onboard UE, it may resume cell measurements and enable cell reselection.

Therefore, it may be proposed that an onboard UE in IDLE/INACTIVE state may no longer perform any cell reselection and associated neighbouring cell measurements. It may also be proposed that when a UE determines that it is no longer an onboard UE, it may resume neighbouring cell measurements and enable cell reselection.

Similarly, an IAB-donor CU should refrain from performing the handover of an onboard UE. In case the onboard UE determination is performed at the UE level, the UE should therefore notify its onboard status to its serving IAB donor CU. Upon reception of such notification from the UE or in case the IAB donor CU determines the onboard status of the UE, the IAB donor CU should no longer perform handover for the considered onboard UE as long as the UE's onboard status remains unchanged.

Therefore, it may be proposed that the onboard status of a UE may be determined either by the UE itself or by its serving IAB donor CU.

It may also be proposed that in case the UE determines a change in its onboard status (i.e., the UE determines it is an onboard UE/the UE determines it is no longer an onboard UE), it should notify its IAB donor CU about its new onboard status.

It may also be proposed that an IAB donor CU should not perform handover for an onboard UE (except in the case of DU migration of the mobile IAB node).

The present invention covers also the following description:

### 1. Regarding Onboard UE Detection:

In RAN2 #119bis, RAN2 observed that a UE could potentially consider itself onboard of a mobile-IAB cell, if the UE camps on/connects to a mobile IAB cell during a long period (i.e., the UE then needs to know that this is such a cell).

In RAN2 #122, RAN2 considered that UEs can use the mIAB-cell indication to prioritize (cell and/or frequency) when the UE is camped on the mIAB cell and to further study the prioritization when the UE is not yet camped on the mIAB cell.

Still, performing the onboard UE detection based on some cell measurement may not be sufficient, as some static UE may be considered as an onboard UE for a static mobile IAB node in case the onboard monitoring time period is not long enough. For instance, the mobile phone of a person waiting for train #A may be considered as an onboard UE for train #B in case train #B remains static at the train station for a too long period. In this respect, as an input for some further study, it was agreed in RAN2 #122 that RAN2 may also consider condition based on cell dwelling timer or Mobility state to decide on when to apply such prioritization (addressing the case 1) where the UE is camped on the mIAB cell and 2) where the UE is not camped on the mIAB cell).

Thus, one may observe that in order to prevent wrong onboard UE detection, the mobility state of a UE should be considered when determining its onboard status.

Based on the above considerations, a UE may be detected, or may detect itself, as an on-board UE for a given mobile IAB cell once the following conditions are met:
The signal strength with the considered mobile IAB cell remains above a minimum threshold for a minimum period of time, which may be evaluated using a cell dwelling timer;
The UE is in a minimum mobility state.

Therefore, it may be proposed that in order to prevent wrong onboard UE detection, a UE may be considered as an on-board UE for a given mobile IAB cell once the following conditions are met:
The signal strength (e.g., RSRP) with the considered mobile IAB node/mobile IAB cell remains above a minimum threshold for a minimum period of time;
The UE is in a minimum mobility state during the considered period of time.

Similarly, an onboard UE having the signal strength (e.g., RSRP) with its serving mobile IAB cell being less than a minimum threshold for a minimum time period may be considered as a surrounding UE (i.e., the UE is no longer considered as an onboard UE).

Therefore, it may be proposed that a UE is no longer considered as an onboard UE if the signal strength (e.g., RSRP) with the mobile IAB cell associated to the vehicle it used to be on-board remains below a minimum threshold for a minimum period of time.

TS 38.304 defines several mobility states (i.e., Normal, Medium, High) based on a number of cell reselections considered during a given time period. This could be reused as a basis for determining the mobility state of an on-board UE. However, the number of cell reselections may not be a relevant parameter when considering an on-board UE already connected to the mobile IAB cell associated to the vehicle it is physically on-board. In such case, it is likely that the on-board UE would remain in most cases connected to its mobile IAB cell. Thus, it would be preferable to define the UE mobility state considering the number of detected fixed cells (instead of the number of cell reselections) during a given time period.

Therefore, it may be proposed that the mobility state of an on-board UE may be determined based on the number of detected fixed cells during a given time period.

### 2. About Cell Reselection/Handover for Onboard UEs:

In RAN2 #122 meeting, RAN2 identified the need to help a UE that is physically on a moving vehicle but not camped on its mobile IAB-cell yet (i.e., the UE is camped on a stationary cell) to identify a neighbour mobile IAB-cell, prioritize this mobile IAB-cell (frequency and cell) and “pull” the UE into this mobile IAB-cell. This is also referred to as “Problem 1”. Indeed, a UE moving along with a mobile IAB cell while not being connected to this mobile cell may experience some frequent handover/cell reselection which may impact the service continuity at UE level.

Thus, one may observe that a UE that is physically on a moving vehicle but not camped/connected on its mobile IAB cell may experience unnecessary handover (for a UE in CONNECTED state) or cell reselection (in case the UE enters the IDLE/INACTIVE state). Therefore, a UE in IDLE/INACTIVE state that determines it is onboard for a mobile IAB cell while not being camped on this mobile IAB-cell yet should perform cell resection from its current camping cell and prioritize the mobile IAB-cell.

Therefore, considering Problem 1, it may be proposed that in case a UE in IDLE/INACTIVE state determines it is onboard for a mobile IAB cell but not camped on this mobile IAB-cell yet (i.e., the UE is camped on a stationary cell), the UE should perform cell resection from its current camping cell and prioritize the mobile IAB-cell associated to the vehicle it is onboard. In order to prevent service discontinuity that would result from the onboard UE device camped on a mobile IAB cell disconnecting from this mobile IAB cell to transiently camp to a stationary cell (managed by a gNB or a fixed IAB node) or to some other mobile IAB cell passing by in the vicinity, an onboard UE in IDLE/INACTIVE state may no longer perform any cell reselection and associated neighbouring cell measurements as long as it remains onboard for the considered mobile IAB node. This is related to “Problem 2” identified in RAN2 #122. Therefore, considering Problem 2, it may be proposed that an onboard UE in IDLE/INACTIVE state that is camped to the mobile IAB-cell associated to the vehicle it is onboard, may no longer perform cell reselection and associated neighbouring cell measurements to any fixed cell as long as it determines it is an onboard UE.

Similarly, in a case where a UE determines that it is no longer an onboard UE, it may resume cell measurements and enable cell reselection.

Therefore, it may be proposed that when a UE determines that it is no longer an onboard UE, it may resume neighbouring cell measurements and enable cell reselection to any cell, either mobile of fixed, in the vicinity.

Considering now an onboard UE in CONNECTED state with a mobile IAB-cell, an IAB-donor CU should refrain from performing the handover of this UE. In case the onboard UE determination is performed at the UE level, the UE should therefore notify its onboard status to its serving IAB donor CU.

Therefore, it may be proposed that the onboard status of a UE may be determined either by the UE itself or by its serving IAB donor CU.

Therefore, it may be proposed that in case the UE determines a change in its onboard status (i.e., the UE determines it is an onboard UE or the UE determines it is no longer an onboard UE), it should notify its IAB donor CU about its new onboard status.

Upon reception of such notification from the UE or in case the IAB donor CU determines the onboard status of the UE for a given mobile IAB-cell, the IAB donor CU should perform one of the following:
In case the onboard UE is connected to a fixed cell, the IAB donor CU should perform handover for the considered onboard UE to a mobile IAB-cell associated to the vehicle for which the UE is onboard.
In case the onboard UE is already connected to the mobile IAB-cell, the IAB donor CU should no longer perform handover for the considered onboard UE to a fixed cell (managed by a gNB or a fixed IAB node) as long as the UE's onboard status remains unchanged.
In case the onboard UE is already connected to the mobile IAB-cell, the IAB donor CU should limit the handover for the considered onboard UE to the other mobile cells which mobile IAB node is mounted on the same vehicle the UE is actually onboard, as the long as the UE's onboard status remains unchanged.

Therefore, it may be proposed that in case an IAB donor CU determines that a UE in CONNECTED state is onboard for a mobile IAB cell but not connected on this mobile IAB-cell yet (i.e., the UE is connected to a stationary cell), the IAB donor CU should perform the handover of the UE from its current serving cell to the mobile IAB-cell associated to the vehicle it is onboard.

It may also be proposed that in case an onboard UE is already connected a mobile IAB-cell associated to the vehicle it is onboard, an IAB donor CU should not perform the handover of this UE to a fixed cell (managed by a gNB or fixed IAB node) until the UE determines it is no longer onboard of the vehicle (except in the case of DU migration of the mobile IAB node). It may also be proposed that in case an onboard UE is already connected a mobile IAB-cell associated to the vehicle it is onboard, an IAB donor CU should limit the handover of this UE to another mobile IAB-cell associated to the same vehicle.

1. A method of determining, in a wireless network comprising a user equipment, UE, connected to a donor Integrated Access and Backhaul, IAB, node via a mobile Integrated Access and Backhaul, mIAB, node, an on-board status of the UE, the method comprising:
monitoring whether an on-board triggering condition is satisfied; and
determining that the UE has an on-board status when the on-board triggering condition is satisfied.

2. The method according to claim 1, wherein the step of monitoring whether an on-board triggering condition is satisfied comprises comparing at least one on-board triggering quantity to an associated triggering threshold.

3. The method according to claim 2, wherein the on-board triggering condition is determined to be satisfied when at least one on-board triggering quantity is equal to or exceeds its associated triggering threshold for the duration of a predetermined on-board triggering period.

4. The method according to claim 3, wherein the on-board triggering condition is determined to be satisfied when at least one on-board triggering quantity is equal to or exceeds its associated triggering threshold for the duration of a predetermined on-board triggering period, while a mobility state of the UE indicates that the UE is moving.

5. The method according to claim 4, wherein the mobility state indicates a rate at which the UE is moving, and wherein the on-board triggering condition is determined to be satisfied when at least one on-board triggering quantity is equal to or exceeds its associated triggering threshold for the duration of a predetermined on-board triggering period, while the mobility state indicates that the rate at which the UE is moving is equal to or exceeds an on-board triggering speed.

6. The method according to claim 4, wherein the mobility state of the UE relates to a number of fixed cells detected by the UE in a predetermined period, or wherein the mobility state of the UE relates to a number of fixed base stations detected by the UE in a predetermined period.

7. (canceled)

8. The method according to claim 5, wherein the number of fixed cells and/or the number of fixed based stations detected by the UE is determined based on one or more of the list comprising:
reference signal received power, RSRP;
reference signal received quality, RSRQ;
signal-to-noise ratio, SNR; and
a channel quality indicator, CQI.

9. The method according to claim 2, wherein at least one on-board triggering quantity comprises one or more of the list comprising:
reference signal received power, RSRP;
reference signal received quality, RSRQ; and
signal-to-interference-plus-noise ratio, SINR.

10. The method according to claim 1, wherein the step of monitoring whether an on-board triggering condition is satisfied comprises monitoring one or more measurement related to the radio link between the UE and the mIAB node.

11. The method according to claim 1, further comprising the step of:
after the UE has been determined to have an on-board status,
continuing to monitor whether an on-board triggering condition is satisfied; and
determining that the UE no longer has an on-board status when the on-board triggering condition is not satisfied, or
after the UE has been determined to have an on-board status with respect to a given mIAB node,
determining whether the UE is connected to said mIAB node; and
in a case where the UE is determined not to be connected to said mIAB node,
connecting the UE to said mIAB node.

12. (canceled)

13. The method according to claim 1, performed by the UE, or the mIAB, or the donor IAB node.

14. (canceled)

15. (canceled)

16. A method for use in managing network connectivity in a wireless communication system including a mobile Integrated Access and Backhaul, mIAB, node, the method at the mIAB node comprising:
generating or receiving an on-board notification message related to a user equipment, UE, the on-board notification message indicating an on-board status of the UE.

17. (canceled)

18. (canceled)

19. The method of claim 16, wherein the method further comprises sending to a donor IAB node a capability information message, wherein the capability information message contains an on-board monitoring configuration.

20. (canceled)

21. (canceled)

22. A method for use in managing network connectivity in a wireless communication system including a mobile Integrated Access and Backhaul, mIAB, node, the method at a user equipment, UE, comprising:
generating or receiving an on-board notification message indicating an on-board status of the UE.

23. The method of claim 22, wherein the method comprises:
receiving the on-board notification message from or via the mIAB node, or the UE, or from a donor IAB node of the wireless communication system.

24. The method of claim 22, wherein the method comprises:
generating the on-board notification message after determining the on-board status of the UE based on an on-board monitoring configuration and on measurements on the radio link between the UE and the mIAB node.

25. The method of claim 24, further comprising the step of:
sending the on-board notification message to the UE, or the mIAB node or to a donor IAB node of the wireless communication system.

26. The method of claim 22, wherein the method further comprises disabling a cell reselection process for the UE when the on-board notification message indicates that the UE has an on-board status, or enabling a cell reselection process for the UE when the on-board notification message indicates that the UE does not have an on-board status.

27-44. (canceled)

45. The method of claim 5, wherein the on-board triggering speed is related to a speed value of the mIAB node, wherein the on-board triggering speed is a minimum speed value of the mIAB node, or a maximum speed value of the mIAB node or an average speed value of the mIAB node or wherein the on-board triggering speed relates to a minimum number of fixed cells and/or fixed base stations detected by the UE during a predetermined time period, or wherein the predetermined time period is the predetermined on-board triggering period.

46-51. (canceled)

52. A non-transitory computer-readable storage medium comprising instructions which, upon execution by a computer, cause the computer to perform the method according to claim 1.

53. (canceled)
